(19) United States
(12) Patent Application Publication
(10) Pub. No.: US 2025/0389657 A1
(43) Pub. Date: Dec. 25, 2025

(54) COMPACT DETECTION SYSTEM

(71) Applicant: GEN-PROBE INCORPORATED, San Diego, CA (US)

(72) Inventors: Norbert D. HAGEN, Carlsbad, CA (US); David OPALSKY, San Diego, CA (US); Ian Daniel KARIN, San Diego, CA (US)

(73) Assignee: GEN-PROBE INCORPORATED, San Diego, CA (US)

(21) Appl. No.: 18/877,699

(22) PCT Filed: Jun. 22, 2023
(86) PCT No.: PCT/IB2023/056475

§ 371 Date: Dec. 20, 2024

Related U.S. Application Data
(60) Provisional application No. 63/367,007, filed on Jun. 24, 2022.

(51) Int. Cl. G01N 21/64

(52) U.S. Cl. CPC G01N 21/645; G01N 2021/6419; G01N 2021/6421; G01N 2021/6478; G01N 2021/6484; G01N 2201/0221; G01N 2201/0826; G01N 2201/0833

(57) ABSTRACT

A system includes two or more illuminators, each illuminator configured to provide excitation light. An excitation waveguide is coupled to each of the illuminators. Each of the excitation waveguides is configured to guide the excitation light from the coupled illuminator to a corresponding location, thereby illuminating at least a portion of the location with the excitation light. A combined-emission waveguide is configured to guide light emitted from the illuminated locations to detection optics. The detection optics include one or more lenses. The detection optics are configured to receive at least a portion of the emitted light provided from the combined-emission waveguide and direct at least a first portion of the received emitted light along a first detection path based on a first wavelength of the received emitted light.

### CROSS REFERENCE TO RELATED APPLICATION

This application claims the benefit of the filing date of U.S. provisional patent application Ser. No. 63/367,007 filed Jun. 24, 2022.

### TECHNICAL FIELD

This disclosure relates to a compact system for illuminating multiple sample regions with excitation light and detecting light emitted from the multiple sample regions with a combined emission waveguide.

### BACKGROUND

Fluorometers are devices used to measure the emission of light from one or more fluorescent species. Fluorometers have broad applicability and can be used to detect fluorescent signals reflecting the results of chemical analyses, immunoassays, nucleic acid-based tests, and the like. By measuring the intensity of a fluorescent signal at a specified wavelength, fluorometers can be used to determine the presence and/or amount of an analyte of interest that is associated with a particular fluorescent “tag.” In an example of a nucleic acid-based test, a fluorometer is used to determine the results of a melt curve analysis, in which double stranded DNA is heated over time, and detection of a fluorescent signal monitored by the fluorometer indicates the temperature range over which the strands of DNA separate. The resulting melt curves can be used to determine whether particular DNA duplexes are present in a sample based on the melting temperature (Tm) of each melt curve, where the more stable the DNA duplex, the higher the melting temperature. In another example of a nucleic acid-based test, fluorometers are used to determine the results of TaqMan PCR assays, during which a probe bound to a nucleic acid of interest is digested, thereby releasing a fluorescent tag from the influence of a quenching moiety. Detection of the fluorescent tag indicates that the associated probe was bound to the nucleic acid of interest, thus indicating the presences of the nucleic acid of interest.

As analytical instruments continue to shrink in size, particularly for field and office based applications, there is a continued need for compact detection systems capable of light-based detection.

### SUMMARY OF THE DISCLOSURE

Most existing systems having multi-analyte detection capability are not portable and can have high manufacturing and operating costs, limiting their usefulness to large-scale testing in controlled environments. As such, a need currently exists for more compact systems that not only meet the requirements of high detection sensitivity and fast measurement speed of modern large-scale instrumentation but can also be deployed in the field or used in an office setting.

This disclosure provides an improved compact detection system that solves these and other technical problems of previous technology. One embodiment of the compact detection system of this disclosure includes at least two illuminators that each provide excitation to a different detection location, such as different detection regions, or wells, of a sample cartridge or other sample holder. Upon illumination, light may be emitted from fluorescent species at the detection location (e.g., from fluorescent tags associated with an analyte of interest). The fluorescence emitted from the illuminated detection locations is guided to shared detection optics via a shared collection waveguide.

In certain embodiments, the shared detection optics are specially arranged components that direct received emission light to one or more detectors, which in turn generate electronic signals (e.g., electronic currents or voltages) used to determine detection results. The detection optics direct signals (e.g., emission light) originating from each detection location that is illuminated by the illuminators, resulting in a more compact and efficiently operated detection system. For example, in certain embodiments, the detection optics include one or more multi-band dichroic filters that facilitate the detection of emission light at two or more wavelengths using the same detector. Furthermore, synchronization and timing of excitation/illumination and detection can be configured to facilitate rapid measurements of multiple analytes (e.g., at multiple wavelengths) in multiple detection locations with fewer detectors and a less complex arrangement than was previously possible, as described further below.

The disclosed compact detection system provides several technical improvements and advantages which may include (1) improved illumination properties (e.g., decreased drift with time, temperature, physical movement, etc.) through the use of a dedicated illuminator for each detection location, which avoids, for example, the use of beam splitters, which can result in considerable attenuation of signal intensity and consequent loss in detection sensitivity and reliability; (2) decreased complexity and improved robustness of illuminators using aperture sharing; (3) decreased system complexity through the use of shared detection optics that are used to detect signals from multiple detection locations; (4) improved speed of measurement in a compact system, enabling sufficiently rapid measurements at multiple wavelengths and in multiple detection locations for use in rapid DNA melt analysis and other relatively high speed measurements; and (5) decreased system size resulting in increased portability and smaller footprint when deployed. The detection system may further have improved robustness and lower cost through the absence of, or decreased use of, moving parts. In certain embodiments, the compact detection system includes few or no moving parts, potentially resulting in a lower cost and more robust portable instrument than was previously available. In some cases, illumination and detection waveguides may be moved to interrogate two or more sets of detection locations. In other embodiments, no moving parts are present.

Certain embodiments of this disclosure may include some, all, or none of these advantages. These advantages, and other features, will be more clearly understood from the following detailed description taken in conjunction with the accompanying drawings and claims.

In an embodiment, a detection system includes two or more illuminators, each illuminator configured to provide excitation light. An excitation waveguide is coupled to each of the illuminators. Each of the excitation waveguides is configured to guide the excitation light from the coupled illuminator to a corresponding location, thereby illuminating at least a portion of the location with the excitation light. A combined-emission waveguide is configured to guide light emitted from the illuminated locations to detection optics. The detection optics include one or more lenses. The detection optics are configured to receive at least a portion of the emitted light provided from the combined-emission waveguide and direct at least a first portion of the received emitted light along a first detection path based on a first wavelength of the received emitted light.

In another embodiment, a method includes providing excitation light from a first illuminator to a first detection location and providing excitation light from a second illuminator to a second detection location. Light emitted from the first detection location is received via a combined-emission waveguide. Light emitted from the second detection location is received via the combined-emission waveguide. At least a portion of the received emitted light is directed to a first detection path based on a first wavelength of the received emitted light.

In yet another embodiment, a system, includes a sample cartridge, a fluorometer, and a first detector. The sample cartridge includes a first reaction zone configured to hold a first volume of fluid for analysis and a second reaction zone configured to hold a second volume of fluid for analysis. The fluorometer is configured to provide excitation light from a first illuminator to the first reaction zone; provide excitation light from a second illuminator to the second reaction zone; receive, via a combined-emission waveguide, light emitted from the first reaction zone; receive, via the combined-emission waveguide, light emitted from the second reaction zone; and direct at least a first portion of the received light to a first detection path based on a first wavelength of the received light. The first detector is positioned along the first detection path and configured to receive at least a portion of the first portion of light directed to the first detection path; and generate a first electronic signal based on the received portion of the first portion of light.

Implementations of the disclosure can be described in view of the following embodiments, the features of which can be combined in any reasonable manner.

Embodiment 1 is a system that includes two or more illuminators, each illuminator is configured to provide excitation light; an excitation waveguide coupled to each of the illuminators, where each of the excitation waveguides is configured to guide the excitation light from the coupled illuminator to a corresponding location, thereby illuminating at least a portion of the corresponding location with the excitation light; a combined-emission waveguide configured to guide light emitted from the illuminated locations to detection optics; and the detection optics include one or more lenses, where the detection optics are configured to receive at least a portion of the emitted light provided from the combined-emission waveguide; and direct a first portion of the received emitted light along a first detection path based on a first wavelength of the received emitted light.

Embodiment 2 is the system of Embodiment 1, where the excitation waveguide coupled to each of the illuminators is held in a fixed position relative to the location illuminated with the excitation light provided by the illuminator.

Embodiment 3 is the system of Embodiment 1, further including a waveguide holder configured to hold the excitation waveguide coupled to each of the illuminators in a fixed position relative to the location illuminated with the excitation light provided by the illuminator.

Embodiment 4 is the system of Embodiment 1, wherein the two or more illuminators include a first illuminator configured to provide excitation light at a first excitation wavelength during a first time interval; and a second illuminator configured to provide excitation light at the first excitation wavelength during a second time interval different from the first time interval.

Embodiment 5 is the system of Embodiment 4, where the second time interval does not overlap with the first time interval.

Embodiment 6 is the system of Embodiment 1, where each illuminator is configured to provide excitation light at different wavelengths simultaneously.

Embodiment 7 is the system of Embodiment 6, where the two or more illuminators include a first illuminator configured to provide excitation light at a first excitation wavelength; and a second illuminator configured to provide excitation light at a second excitation wavelength different from the first excitation wavelength.

Embodiment 8 is the system of Embodiment 7, where a peak intensity of the excitation light provided by the first illuminator at the first excitation wavelength is at least 15 nm from a peak intensity of the excitation light provided by the second illuminator at the second excitation wavelength.

Embodiment 9 is the system of Embodiment 7, where the first illuminator is configured to provide excitation light at the first excitation wavelength during a first time interval, and where the second illuminator is configured to provide excitation light at the second excitation wavelength during at least a portion of the first time interval.

Embodiment 10 is the system of Embodiment 6, where the two or more illuminators include a first illuminator configured to provide excitation light at a first excitation wavelength during a first time interval; and a second illuminator configured to provide excitation light at a second excitation wavelength during a second time interval different from the first time interval.

Embodiment 11 is the system of Embodiment 1, where at least one of the illuminators is configured to provide excitation light at multiple wavelengths.

Embodiment 12 is the system of Embodiment 11, where the two or more illuminators include a first illuminator configured to provide excitation light at a first excitation wavelength and a second excitation wavelength different from the first excitation wavelength; and a second illuminator configured to provide excitation light at a third excitation wavelength different from the first and second excitation wavelengths.

Embodiment 13 is the system of Embodiment 11, where the two or more illuminators include a first illuminator configured to provide excitation light at a first excitation wavelength and a second excitation wavelength different from the first excitation wavelength during a first time interval; and a second illuminator configured to provide excitation light at one or both of the first excitation wavelength and the second excitation wavelength during a second time interval different from the first time interval.

Embodiment 14 is the system of Embodiment 11, where the two or more illuminators include a first illuminator configured to provide excitation light at a first excitation wavelength and a second excitation wavelength different from the first excitation wavelength; and a second illuminator configured to provide excitation light at a third excitation wavelength and a fourth excitation wavelength different from the third excitation wavelength, each of the third and fourth excitation wavelengths being different from the first and second excitation wavelengths.

Embodiment 15 is the system of Embodiment 1, where each of the illuminators further comprises a set of light sources, each of the light sources being configured to emit light at a wavelength different from the other light sources.

Embodiment 16 is the system of Embodiment 15, where each of the illuminators further comprises a set of collimating lenses, each collimating lens being associated with one of the light sources and being configured to collimate light emitted by the associated light source.

Embodiment 17 is the system of Embodiment 16, where each of the illuminators further comprises a set of excitation filters, each excitation filter being associated with one of the collimating lenses and its associated light source and being configured to receive the light collimated by the associated collimating lens and filter the collimated light to prevent transmission of a first portion of the collimated light in a first wavelength range and allow transmission of a second portion of the collimated light in a second wavelength range, where the second wavelength range encompasses an excitation wavelength of the excitation light provided by the illuminator.

Embodiment 18 is the system of Embodiment 17, where each of the illuminators further includes an aperture-sharing lens configured to: receive the filtered collimated light from the set of excitation filters; and direct the received light to the excitation waveguide coupled to the illuminator.

Embodiment 19 is the system of Embodiment 1, where each of the illuminators further includes a first light source and a second light source.

Embodiment 20 is the system of Embodiment 19, where each of the illuminators further includes a set of collimating lenses including for the first light source, a first collimating lens configured to collimate light emitted by the first light source; and for the second light source, a second collimating lens configured to collimate light emitted by the second light source.

Embodiment 21 is the system of Embodiment 20, where each of the illuminators further comprises a set of excitation filters including for the first collimating lens, a first excitation filter configured to receive the light collimated by the first collimating lens and filter the light collimated by the first collimating lens to prevent transmission of a first portion of the light collimated by the first collimating lens in a first wavelength range and allow transmission of a second portion of the light collimated by the first collimating lens in a second wavelength range, where the second wavelength range encompasses a first excitation wavelength of the excitation light provided by the illuminator; and for the second collimating lens, a second excitation filter configured to receive the light collimated by the second collimating lens and filter the light collimated by the second collimating lens to prevent transmission of a first portion of the light collimated by the second collimating lens in a third wavelength range and allow transmission of a second portion of the light collimated by the second collimating lens in a fourth wavelength range, where the fourth wavelength range encompasses a second excitation wavelength of the excitation light provided by the illuminator.

Embodiment 22 is the system of Embodiment 21, where each of the illuminators further comprises an aperture-sharing lens set including a first lens configured to receive light filtered by both the first excitation filter and the second excitation filter; and a second lens configured to direct the received light to the excitation waveguide coupled to the illuminator.

Embodiment 23 is the system of Embodiment 1, where the two or more illuminators include a first illuminator including at least two first light sources, each first light source configured to emit light at a wavelength, where the wavelength of light emitted by each first light source is different from the wavelength of light emitted by other first light sources; one or more first lenses configured to direct light from the at least two first light sources to the excitation waveguide coupled to the first illuminator; and a second illuminator including at least two second light sources, each second light source configured to emit light at a wavelength, where the wavelength of light emitted by each second light source is different from the wavelength of light emitted by other second light sources; one or more second lenses configured to direct light from the at least two second light sources to the excitation waveguide coupled to the second illuminator.

Embodiment 24 is the system of Embodiment 23, where each light source of the at least two first light sources emits light at the same wavelength as a corresponding light source of the at least two second light sources.

Embodiment 25 is the system of Embodiment 1, where the location corresponding to each illuminator is a reaction zone associated with detecting or measuring an analyte using an analyte recognition tag.

Embodiment 26 is the system of Embodiment 25, where the reaction zone is configured to hold a volume of fluid including a test solution and the analyte recognition tag, where the analyte recognition tag is configured, during or after interaction with the analyte, to emit emission light in response to irradiation with excitation light provided by the illuminator.

Embodiment 27 is the system of Embodiment 25, where the light emitted from the illuminated reaction zones includes at least a portion of emission light from the analyte recognition tag.

Embodiment 28 is the system of Embodiment 25, where the reaction zone includes at least a portion of a reaction chamber of a sample cartridge.

Embodiment 29 is the system of Embodiment 1, further including, for each location, an emission waveguide associated with the location and configured to receive emitted light from the location and guide the received emitted light to the combined-emission waveguide.

Embodiment 30 is the system of Embodiment 29, further including a waveguide coupler configured to combine the emission waveguides associated with each of the locations, such that light guided by each emission waveguide is provided to the combined-emission waveguide.

Embodiment 31 is the system of Embodiment 29, where the emission waveguide associated with each location is held in a fixed position relative to the location.

Embodiment 32 is the system of Embodiment 31, further including a waveguide holder configured to hold the emission waveguide associated with each location in the fixed position relative to the location.

Embodiment 33 is the system of Embodiment 1, where the detection optics further comprise one or more collimating lenses configured to receive light from the combined-emission waveguide; and collimate the received light.

Embodiment 34 is the system of Embodiment 1, where the detection optics further comprise a first dichroic filter configured to direct the first portion of the collimated light along the first detection path and allow a second portion of the collimated light to proceed towards a second dichroic filter; and the second dichroic filter is configured to direct a portion of the second portion of the collimated light along a second detection path.

Embodiment 35 is the system of Embodiment 34, where the first portion of the collimated light is in a first wavelength range corresponding to an emission wavelength of an analyte recognition tag.

Embodiment 36 is the system of Embodiment 34, where the first dichroic filter is a multi-band dichroic filter, and the first portion of the collimated light directed along the first detection path includes one or both of a first emission wavelength of a first analyte recognition tag and a second emission wavelength of a second analyte recognition tag.

Embodiment 37 is the system of Embodiment 36, where the second dichroic filter is a multi-band dichroic filter, and the portion of the second portion of the collimated light directed along the second detection path includes one or both of a third emission wavelength of a third analyte recognition tag and a fourth emission wavelength of a fourth analyte recognition tag.

Embodiment 38 is the system of Embodiment 34, further including a detection module including a first detector positioned in the first detection path and configured to generate a first electronic signal in response to light reaching the first detector; and a second detector positioned in the second detection path and configured to generate a second electronic signal in response to light reaching the second detector.

Embodiment 39 is the system of Embodiment 1, further including a detector module including a detector positioned in the first detection path and configured to generate an electronic signal in response to light reaching the detector.

Embodiment 40 is the system of Embodiment 1, where the detection optics are further configured to direct a second portion of the received emitted light to a second detection path based on a second wavelength of the received emitted light.

Embodiment 41 is the system of Embodiment 1, where the two or more illuminators include a first illuminator configured to provide excitation light to a first reaction zone at a first excitation wavelength during a first time interval, where the first reaction zone is associated with a first analyte recognition tag configured, in the presence of an analyte, to emit emission light in response to irradiation with the excitation light, and where the location corresponding to the first illuminator includes the first reaction zone; and a second illuminator configured to provide excitation light to a second reaction zone at the first excitation wavelength during a second time interval, where the second reaction zone is associated with a second analyte recognition tag configured, in the presence of an analyte, to emit emission light in response to irradiation with the excitation light, the first analyte recognition tag and the second analyte recognition tag being the same analyte recognition tag, and where the location corresponding to the second illuminator includes the second reaction zone; a first emission waveguide is configured to receive emission light emitted from the first reaction zone and provide the emission light to the combined-emission waveguide; a second emission waveguide is configured to receive emission light emitted from the second reaction zone and provide the emission light to the combined-emission waveguide; and a detector is positioned along the first detection path and configured to receive at least a portion of the first portion of light directed along the first detection path; and generate an electronic signal based on the received light, where a first electronic signal generated during the first time interval indicates one or both of a presence and amount of the analyte in the first reaction zone and a second electronic signal generated during the second time interval indicates one or both of a presence and amount of the analyte in the second reaction zone.

Embodiment 42 is the system of Embodiment 1, where the two or more illuminators include a first illuminator configured to provide excitation light to a first reaction zone at a plurality of excitation wavelengths during a first time interval, where the first reaction zone is associated with a plurality of first analyte recognition tags, each analyte recognition tag of the plurality of first analyte recognition tags being configured, in the presence of a corresponding analyte, to emit emission light at a corresponding emission wavelength in response to irradiation with an excitation wavelength of the first plurality of wavelengths; and a second illuminator configured to provide excitation light to a second reaction zone at the plurality of excitation wavelengths during a second time interval, where the second reaction zone is associated with a plurality of second analyte recognition tags, each analyte recognition tag of the plurality of second analyte recognition tags being configured, in the presence of a corresponding analyte, to emit emission light at a corresponding emission wavelength in response to irradiation with an excitation wavelength of the first plurality of wavelengths, and where the plurality of first analyte recognition tags and the plurality of second analyte recognition tags are the same analyte recognition tags; a first emission waveguide is configured to receive emission light emitted from the first reaction zone and provide the emission light from the first reaction zone to the combined-emission waveguide; a second emission waveguide is configured to receive emission light emitted from the second reaction zone and provide the emission light from the second reaction zone to the combined-emission waveguide; the detection optics are further configured to receive light from the combined-emission waveguide; direct light from the combined-emission waveguide to two or more detection paths based on a wavelength of the received light, where the two or more detection paths include the first detection path; and a detection module comprises a detector positioned in each of the two or more detection paths, where the detector positioned in each detection path is configured to receive at least a portion of the light directed along the detection path; and generate an electronic signal based on the received light.

Embodiment 43 is the system of Embodiment 42, where a first electronic signal generated by the detection module during the first time interval indicates one or both of a presence and amount of an analyte detectable by the analyte recognition tags in the first reaction zone; and a second electronic signal generated by the detection module during the second time interval indicates one or both of a presence and amount of an analyte detectable by the analyte recognition tags in the second reaction zone.

Embodiment 44 is the system of Embodiment 1, where the two or more illuminators include a first illuminator configured to provide excitation light to a first reaction zone at a first excitation wavelength during a first time interval and at a second excitation wavelength during a second time interval different from the first time interval, where the first reaction zone is associated with a first analyte recognition tag configured, in the presence of a first analyte, to emit emission light at a first emission wavelength in response to irradiation with the excitation light at the first excitation wavelength, and a second analyte recognition tag configured, in the presence of a second analyte, to emit emission light at a second emission wavelength in response to irradiation with the excitation light at the second excitation wavelength; and a second illuminator configured to provide excitation light to a second reaction zone at the first excitation wavelength during a third time interval and at the second excitation wavelength during a fourth time interval, where the second reaction zone is associated with the first analyte recognition tag and the second analyte recognition tag; and a first emission waveguide is configured to receive emission light emitted from the first reaction zone and provide the emission light to the combined-emission waveguide; a second emission waveguide is configured to receive emission light emitted from the second reaction zone and provide the emission light to the combined-emission waveguide; the detection optics comprise a dual-band dichroic filter configured to direct the light at the first emission wavelength and the second emission wavelength along the first detection path; and a detector is positioned along the first detection path and configured to receive at least a portion of light directed along the first detection path; and generate an electronic signal based on the received light.

Embodiment 45 is the system of Embodiment 44, where during the first time interval, a first electronic signal generated by the detector indicates one or both of a presence and amount of the first analyte in the first reaction zone; during the second time interval, a second electronic signal generated by the detector indicates one or both of a presence and amount of the second analyte in the first reaction zone; during the third time interval, a third electronic signal generated by the detector indicates one or both of a presence and amount of the first analyte in the second reaction zone; and during the fourth time interval, a fourth electronic signal generated by the detector indicates one or both of a presence and amount of the second analyte in the second reaction zone.

Embodiment 46 is the system of Embodiment 1, where the two or more illuminators include a first illuminator configured to provide excitation light to a first reaction zone at a first excitation wavelength and a second excitation wavelength during a first time interval and at a third excitation wavelength and a fourth excitation wavelength during a second time interval, where the first reaction zone is associated with a first analyte recognition tag configured, in the presence of a first analyte, to emit emission light at a first emission wavelength in response to irradiation with the excitation light at the first excitation wavelength; a second analyte recognition tag configured, in the presence of a second analyte, to emit emission light at a second emission wavelength in response to irradiation with the excitation light at the second excitation wavelength; a third analyte recognition tag configured, in the presence of a third analyte, to emit emission light at a third emission wavelength in response to irradiation with the excitation light at the third excitation wavelength; and a fourth analyte recognition tag configured, in the presence of a fourth analyte, to emit emission light at a fourth emission wavelength in response to irradiation with the excitation light at the fourth excitation wavelength; and a second illuminator configured to provide excitation light to a second reaction zone at the first excitation wavelength and the second excitation wavelength during a third time interval and at the third excitation wavelength and the fourth excitation wavelength during a fourth time interval, where the second reaction zone is associated with the first, second, third, and fourth analyte recognition tags; a first emission waveguide is configured to receive emission light emitted from the first reaction zone and provide the emission light to the combined-emission waveguide; a second emission waveguide is configured to receive emission light emitted from the second reaction zone and provide the emission light to the combined-emission waveguide; the detection optics include a first multi-band dichroic filter configured to direct light at the first emission wavelength and the third emission wavelength along the first detection path; and a second multi-band dichroic filter configured to direct light at the second emission wavelength and the fourth emission wavelength along a second detection path; and a detection module comprises a first detector positioned along the first detection path and configured to receive at least a portion of light directed along the first detection path; and generate a first electronic signal based on the received light; and a second detector positioned along the second detection path and configured to receive at least a portion of light directed along the second detection path; and generate a second electronic signal based on the received light.

Embodiment 47 is the system of Embodiment 46, where during the first time interval, the first electronic signal indicates one or both of a presence and amount of the first analyte in the first reaction zone and the second electronic signal indicates one or both of a presence and amount of the second analyte in the first reaction zone; during the second time interval, the first electronic signal indicates one or both of a presence and amount of the third analyte in the first reaction zone and the second electronic signal indicates one or both of a presence and amount of the fourth analyte in the first reaction zone; during the third time interval, the first electronic signal indicates one or both of a presence and amount of the first analyte in the second reaction zone and the second electronic signal indicates one or both of a presence and amount of the second analyte in the second reaction zone; and during the fourth time interval, the first electronic signal indicates one or both of a presence and amount of the third analyte in the second reaction zone and the second electronic signal indicates one or both of a presence and amount of the fourth analyte in the second reaction zone.

Embodiment 48 is the system of Embodiment 46, where the first reaction zone and the second reaction zone each further comprise a fifth analyte recognition tag configured, in the presence of a fifth analyte, to emit emission light at a fifth emission wavelength in response to irradiation with the excitation light at the fifth excitation wavelength; the first illuminator is further configured to provide excitation light to the first reaction zone at the fifth excitation wavelength during a fifth time interval; the second illuminator is further configured to provide excitation light to the second reaction zone at the fifth excitation wavelength during a sixth time interval; and the first multi-band dichroic filter is further configured to direct light at the fifth emission wavelength along the first detection path.

Embodiment 49 is the system of 48, where during the fifth time interval, the first electronic signal indicates one or both of a presence and amount of the fifth analyte in the first reaction zone; and during the sixth time interval, the first electronic signal indicates one or both of a presence and amount of the fifth analyte in the second reaction zone.

Embodiment 50 is the system of Embodiment 1, where the two or more illuminators include a first illuminator configured to provide excitation light to a first reaction zone at a first excitation wavelength during a first time interval, where the first reaction zone is associated with a first analyte recognition tag configured, in the presence of a first analyte, to emit emission light at a first emission wavelength in response to irradiation with the excitation light at the first excitation wavelength; and a second illuminator configured to provide excitation light to a second reaction zone at a second excitation wavelength during the first time interval, where the second reaction zone is associated with a second analyte recognition tag configured, in the presence of a second analyte, to emit emission light at a second emission wavelength in response to irradiation with the excitation light at the second excitation wavelength; a first emission waveguide is configured to receive emission light emitted from the first reaction zone and provide the emission light to the combined-emission waveguide; a second emission waveguide is configured to receive emission light emitted from the second reaction zone and provide the emission light to the combined-emission waveguide; the detection optics include a first dichroic filter configured to direct light at the first emission wavelength along a first detection path; and a second dichroic filter configured to direct light at the second emission wavelength along a second detection path; and a detection module comprise a first detector positioned along the first detection path, the first detector configured to receive at least a portion of light directed along the first detection path; and generate a first electronic signal based on the received light; and a second detector positioned along the second detection path, the second detector configured to receive at least a portion of light directed along the second detection path; and generate a second electronic signal based on the received light.

Embodiment 51 is the system of Embodiment 50, where, during the first time interval: the first electronic signal indicates one or both of a presence and amount of the first analyte in the first sample; and the second electronic signal indicates one or both of a presence and amount of the second analyte in the second reaction zone.

Embodiment 52 is the system of Embodiment 1, where the system is configured to index between a first position and a second position, where in the first position, the excitation waveguides coupled to the two or more illuminators are configured to guide the excitation light to a first set of detection locations; and in the second position, the excitation waveguides coupled to the two or more illuminators are configured to guide the excitation light to a second set of detection locations.

Embodiment 53 is a method, including providing excitation light from a first illuminator to a first detection location; providing excitation light from a second illuminator to a second detection location; receiving, via a combined-emission waveguide, light emitted from the first detection location; receiving, via the combined-emission waveguide, light emitted from the second detection location; and directing at least a portion of the received emitted light from the first and second detection locations to a first detection path based on a first wavelength of the received emitted light.

Embodiment 54 is the method of Embodiment 53, further including holding one or both of (i) a first excitation waveguide coupled to the first illuminator in a fixed position relative to the first detection location and (ii) a second excitation waveguide coupled to the second illuminator in a fixed position relative to the second detection location.

Embodiment 55 is the method of Embodiment 53, further including: providing the excitation light from the first illuminator at a first excitation wavelength during a first time interval; and providing the excitation light from the second illuminator at the first excitation wavelength during a second time interval different from the first time interval.

Embodiment 56 is the method of Embodiment 55, where the second time interval does not overlap with the first time interval.

Embodiment 57 is the method of Embodiment 53, where providing the excitation light from the first illuminator and providing the excitation light from the second illuminator are performed simultaneously.

Embodiment 58 is the method of Embodiment 57, further including: providing the excitation light from the first illuminator at a first excitation wavelength; and providing the excitation light from the second illuminator at a second excitation wavelength different from the first excitation wavelength.

Embodiment 59 is the method of Embodiment 58, where a peak intensity of the excitation light provided by the first illuminator at the first excitation wavelength is at least 15 nm from a peak intensity of the excitation light provided by the second illuminator at the second excitation wavelength.

Embodiment 60 is the method of Embodiment 53, further including providing the excitation light from the first illuminator at a first excitation wavelength during a first time interval; and providing the excitation light from the second illuminator at a second excitation wavelength different from the first time interval during a second time interval different from the first time interval.

Embodiment 61 is the method of Embodiment 53, further including providing one or both of the excitation light from the first illuminator at multiple wavelengths and the excitation light from the second illuminator at multiple wavelengths.

Embodiment 62 is the method of Embodiment 53, further including providing the excitation light from the first illuminator at a first excitation wavelength and a second excitation wavelength different from the first excitation wavelength; and providing the excitation light from the second illuminator at a third excitation wavelength different from the first and second excitation wavelengths.

Embodiment 63 is the method of Embodiment 53, further including providing the excitation light from the first illuminator at a first excitation wavelength and a second excitation wavelength different from the first excitation wavelength during a first time interval; and providing the excitation light from the second illuminator at one or both of the first excitation wavelength and the second excitation wavelength during a second time interval different from the first time interval.

Embodiment 64 is the method of Embodiment 53, further including providing the excitation light from the first illuminator at a first excitation wavelength and a second excitation wavelength different from the first excitation wavelength; and providing the excitation light from the second illuminator at a third excitation wavelength and a fourth excitation wavelength different from the third excitation wavelength, each of the third and fourth excitation wavelengths being different from the first and second excitation wavelengths.

Embodiment 65 is the method of Embodiment 53, further including emitting excitation light from a light source.

Embodiment 66 is the method of Embodiment 65, further including collimating lenses configured to collimating the light emitted by the light source.

Embodiment 67 is the method of Embodiment 66, further including receiving, by one or more filters, the collimated light; and filtering the collimated light to prevent transmission of a first portion of the collimated light in a first wavelength range and allow transmission of a second portion of the collimated light in a second wavelength range, where the second wavelength range encompasses an excitation wavelength of the excitation light provided by the first illuminator.

Embodiment 68 is the method of Embodiment 67, further including, using an aperture-sharing lens receiving, by an aperture sharing lens, the filtered collimated light; and directing the received light to an excitation waveguide coupled to the first illuminator.

Embodiment 69 is the method of Embodiment 53, further including, for the first illuminator, emitting light at a first wavelength from a first light source; and emitting light at a second wavelength different than the first wavelength from a second light source.

Embodiment 70 is the method of Embodiment 69, further including, using a set of collimating lenses collimating light emitted by the first light source using a first collimating lens of the set of collimating lenses; and collimating light emitted by the second light source using a second collimating lens of the set of collimating lenses.

Embodiment 71 is the method of Embodiment 70, further including using a first excitation filter receiving the light collimated by the first collimating lens; and filtering the light collimated by the first collimating lens to prevent transmission of a first portion of the light collimated by the first collimating lens in a first wavelength range and allow transmission of a second portion of the light collimated by the first collimating lens in a second wavelength range, where the second wavelength range encompasses a first excitation wavelength of the excitation light provided by the first illuminator; and using a second excitation filter receiving the light collimated by the second collimating lens; and filtering the light collimated by the second collimating lens to prevent transmission of a first portion of the light collimated by the second collimating lens in a third wavelength range and allow transmission of a second portion of the light collimated by the second collimating lens in a fourth wavelength range, where the fourth wavelength range encompasses a second excitation wavelength of the excitation light provided by the second illuminator.

Embodiment 72 is the method of Embodiment 71, further including receiving light filtered by both the first excitation filter and the second excitation filter; and directing the received light to an excitation waveguide coupled to the first illuminator.

Embodiment 73 is the method of Embodiment 53, where the first detection location is a reaction zone associated with detecting or measuring an analyte using an analyte recognition tag.

Embodiment 74 is the method of Embodiment 73, where the reaction zone is configured to hold a volume of fluid including a test solution and the analyte recognition tag, where the analyte recognition tag is configured, during or after interaction with the analyte, to emit emission light in response to irradiation with excitation light provided by the illuminator.

Embodiment 75 is the method of Embodiment 73, where the light emitted from the reaction zone includes at least a portion of emission light from the analyte recognition tag.

Embodiment 76 is the method of Embodiment 73, where the reaction zone includes at least a portion of a reaction chamber of a sample cartridge.

Embodiment 77 is the method of Embodiment 53, further including using a first emission waveguide receiving, light emitted from the first detection location; and guiding the light emitted from the first detection location to the combined-emission waveguide; and using a second emission waveguide receiving light emitted from the second detection location; and guiding the light emitted from the second detection location to the combined-emission waveguide.

Embodiment 78 is the method of Embodiment 77, further including combining the light emitted from the first and second detection locations via the combined-emission waveguide.

Embodiment 79 is the method of Embodiment 77, holding the first emission waveguide and the second emission waveguide in fixed locations relative to the first and second detection locations.

Embodiment 80 is the method of Embodiment 53, further including receiving light from the combined-emission waveguide; and collimating the received light.

Embodiment 81 is the method of Embodiment 80, further including directing at least a first portion of the collimated light along the first detection path; allowing a second portion of the collimated light to proceed along a collection path; and directing at least a portion of the second portion of the collimated light along a second detection path.

Embodiment 82 is the method of Embodiment 81, where the first portion of the collimated light is in a first wavelength range corresponding to an emission wavelength of an analyte recognition tag.

Embodiment 83 is the method of Embodiment 81, where the at least the first portion of the collimated light directed along the first detection path includes one or both of a first emission wavelength of a first analyte recognition tag and a second emission wavelength of a second analyte recognition tag.

Embodiment 84 is the method of Embodiment 83, where the second portion of the collimated light directed along the second detection path includes one or both of a third emission wavelength of a third analyte recognition tag and a fourth emission wavelength of a fourth analyte recognition tag.

Embodiment 85 is the method of Embodiment 81, further including generating a first electronic signal in response to light reaching a first detector positioned in the first detection path; and generating a second electronic signal in response to light reaching a second detector positioned in the second detection path.

Embodiment 86 is the method of Embodiment 53, further including providing the excitation light from the first illuminator to a first reaction zone associated with the first detection location at a first excitation wavelength during a first time interval, where the first reaction zone is associated with a first analyte recognition tag configured, in the presence of an analyte, to emit emission light in response to irradiation with the excitation light, and where the first reaction zone is the location corresponding to the first illuminator; and providing the excitation light from the second illuminator to a second reaction zone associated with the second detection location at the first excitation wavelength during a second time interval, where the second reaction zone is associated with a second analyte recognition tag configured, in the presence of an analyte, to emit emission light in response to irradiation with the excitation light, the first analyte recognition tag and the second analyte recognition tag being the same analyte recognition tag, and where the second reaction zone is the location corresponding to the second illuminator; receiving, using a first emission waveguide, emission light emitted from the first reaction zone and providing the emission light to the combined-emission waveguide; receiving, using a second emission waveguide, emission light emitted from the second reaction zone and providing the emission light to the combined-emission waveguide; receiving, by a detector is positioned along the first detection path, at least a first portion of light directed along the first detection path; and generating an electronic signal based on the received light, where a first electronic signal generated during the first time interval indicates one or both of a presence and amount of the analyte in the first reaction zone and a second electronic signal generated during the second time interval indicates one or both of a presence and amount of the analyte in the second reaction zone.

Embodiment 87 is the method of Embodiment 53, further including providing the excitation light from the first illuminator to a first reaction zone associated with the first detection location at a plurality of excitation wavelengths during a first time interval, where the first reaction zone is associated with a plurality of first analyte recognition tags, each analyte recognition tag of the plurality of first analyte recognition tags being configured, in the presence of a corresponding analyte, to emit emission light at a corresponding emission wavelength in response to irradiation with an excitation wavelength of the first plurality of wavelengths; and providing the excitation light from the second illuminator to a second reaction zone associated with the second detection location at the plurality of excitation wavelengths during a second time interval, where the second reaction zone is associated with a plurality of second analyte recognition tags, each analyte recognition tag of the plurality of second analyte recognition tags being configured, in the presence of a corresponding analyte, to emit emission light at a corresponding emission wavelength in response to irradiation with an excitation wavelength of the first plurality of wavelengths, and where the plurality of first analyte recognition tags and the plurality of second analyte recognition tags are the same analyte recognition tags; receiving, using a first emission waveguide, emission light emitted from the first reaction zone and providing the emission light from the first reaction zone to the combined-emission waveguide; receiving, using a second emission waveguide, emission light emitted from the second reaction zone and providing the emission light from the second reaction zone to the combined-emission waveguide; receiving, by one or more lenses, light from the combined-emission waveguide; directing light from the combined-emission waveguide to two or more detection paths based on a wavelength of the received light, where the two or more detection paths include the first detection path; and generating electronic signals based at least in part on light received at a plurality of detectors positioned along the two or more detection paths, where a first electronic signal generated during the first time interval indicates one or both of a presence and amount of at least one of a plurality of analytes in the first reaction zone and a second electronic signal generated during the second time interval indicates one or both of a presence and amount of at least one of the plurality of analytes in the second reaction zone.

Embodiment 88 is the method of Embodiment 87, where a first electronic signal generated by a first detector during the first time interval indicates one or both of a presence and amount of an analyte detectable by the analyte recognition tags in the first reaction zone; and a second electronic signal generated by a second detector during the second time interval indicates one or both of a presence and amount of an analyte detectable by the analyte recognition tags in the second reaction zone.

Embodiment 89 is the method of Embodiment 53, further including providing the excitation light from the first illuminator to a first reaction zone associated with the first detection location at a first excitation wavelength during a first time interval and at a second excitation wavelength during a second time interval different from the first time interval, where the first reaction zone is associated with a first analyte recognition tag configured, in the presence of a first analyte, to emit emission light at a first emission wavelength in response to irradiation with the excitation light at the first excitation wavelength, and a second analyte recognition tag configured, in the presence of a second analyte, to emit emission light at a second emission wavelength in response to irradiation with the excitation light at the second excitation wavelength; and providing the excitation light from the second illuminator to a second reaction zone associated with the second detection location at the first excitation wavelength during a third time interval and at the second excitation wavelength during a fourth time interval, where the second reaction zone is associated with the first analyte recognition tag and the second analyte recognition tag; receiving, using a first emission waveguide, emission light emitted from the first reaction zone and providing the emission light to the combined-emission waveguide; receiving, using a second emission waveguide, emission light emitted from the second reaction zone and providing the emission light to the combined-emission waveguide; directing, using a dual-band dichroic filter, the light at the first emission wavelength and the second emission wavelength along the first detection path; and generating an electronic signal based on light received at a detector is positioned along the first detection path, where a first electronic signal generated during the first time interval indicates one or both of a presence and amount of a first analyte in the first reaction zone, a second electronic signal generated during the second time interval indicates one or both of a presence and amount of a second analyte in the first reaction zone, a third electronic signal generated during the third time interval indicates one or both of a presence and amount of the first analyte in the second reaction zone, and a fourth electronic signal generated during the fourth time interval indicates one or both of a presence and amount of the second analyte in the second reaction zone.

Embodiment 90 is the method of Embodiment 89, where during the first time interval, a first electronic signal generated by the detector indicates one or both of a presence and amount of the first analyte in the first reaction zone; during the second time interval, a second electronic signal generated by the detector indicates one or both of a presence and amount of the second analyte in the first reaction zone; during the third time interval, a third electronic signal generated by the detector indicates one or both of a presence and amount of the first analyte in the second reaction zone; and during the fourth time interval, a fourth electronic signal generated by the detector indicates one or both of a presence and amount of the second analyte in the second reaction zone.

Embodiment 91 is the method of Embodiment 53, further including providing the excitation light from the first illuminator to a first reaction zone associated with the first detection location at a first excitation wavelength and a second excitation wavelength during a first time interval and at a third excitation wavelength and a fourth excitation wavelength during a second time interval, where the first reaction zone is associated with: a first analyte recognition tag configured, in the presence of a first analyte, to emit emission light at a first emission wavelength in response to irradiation with the excitation light at the first excitation wavelength; a second analyte recognition tag configured, in the presence of a second analyte, to emit emission light at a second emission wavelength in response to irradiation with the excitation light at the second excitation wavelength; a third analyte recognition tag configured, in the presence of a third analyte, to emit emission light at a third emission wavelength in response to irradiation with the excitation light at the third excitation wavelength; and a fourth analyte recognition tag configured, in the presence of a fourth analyte, to emit emission light at a fourth emission wavelength in response to irradiation with the excitation light at the fourth excitation wavelength; and providing the excitation light from the second illuminator to a second reaction zone associated with the second detection location at the first excitation wavelength and the second excitation wavelength during a third time interval and at the third excitation wavelength and the fourth excitation wavelength during a fourth time interval, where the second reaction zone is associated with the first, second, third, and fourth analyte recognition tags; receiving, using a first emission waveguide, emission light emitted from the first reaction zone and providing the emission light to the combined-emission waveguide; receiving, using a second emission waveguide, emission light emitted from the second reaction zone and providing the emission light to the combined-emission waveguide; directing, using a first multi-band dichroic filter, light at the first emission wavelength and the third emission wavelength along the first detection path; directing, using a second multi-band dichroic filter, light at the second emission wavelength and the fourth emission wavelength along a second detection path; receiving at least a portion of light directed along the first detection path at a first detector positioned along the first detection path; generating a first electronic signal based on light received by the first detector; receiving at least a portion of light directed along the second detection path at a second detector positioned along the second detection path; generating a second electronic signal based on light received by the second detector.

Embodiment 92 is the method of Embodiment 91, where during the first time interval, the first electronic signal indicates one or both of a presence and amount of the first analyte in the first reaction zone and the second electronic signal indicates one or both of a presence and amount of the second analyte in the first reaction zone; during the second time interval, the first electronic signal indicates one or both of a presence and amount of the third analyte in the first reaction zone and the second electronic signal indicates one or both of a presence and amount of the fourth analyte in the first reaction zone; during the third time interval, the first electronic signal indicates one or both of a presence and amount of the first analyte in the second reaction zone and the second electronic signal indicates one or both of a presence and amount of the second analyte in the second reaction zone; and during the fourth time interval, the first electronic signal indicates one or both of a presence and amount of the third analyte in the second reaction zone and the second electronic signal indicates one or both of a presence and amount of the fourth analyte in the second reaction zone.

Embodiment 93 is the method of Embodiment 91, where the first reaction zone and the second reaction zone each further comprise a fifth analyte recognition tag configured, in the presence of a fifth analyte, to emit emission light at a fifth emission wavelength in response to irradiation with the excitation light at the fifth excitation wavelength; and the method further comprises providing the excitation light from the first illuminator to the first reaction zone at the fifth excitation wavelength during a fifth time interval; providing the excitation light from the second illuminator to the second reaction zone at the fifth excitation wavelength during a sixth time interval; directing light at the fifth emission wavelength along the first detection path; generating a third electronic signal during the fifth time interval based on light received by the first detector; and generating a fourth electronic signal during the sixth time interval based on light received by the first detector.

Embodiment 94 is the method of Embodiment 93, where during the fifth time interval, the third electronic signal indicates one or both of a presence and amount of the fifth analyte in the first reaction zone; and during the sixth time interval, the fourth electronic signal indicates one or both of a presence and amount of the fifth analyte in the second reaction zone.

Embodiment 95 is the method of Embodiment 53, where providing the excitation light from the first illuminator to a first reaction zone associated with the first detection location at a first excitation wavelength during a first time interval, where the first reaction zone is associated with a first analyte recognition tag configured, in the presence of a first analyte, to emit emission light at a first emission wavelength in response to irradiation with the excitation light at the first excitation wavelength; providing the excitation light from the second illuminator to a second reaction zone associated with the second detection location at a second excitation wavelength during the first time interval, where the second reaction zone is associated with a second analyte recognition tag configured, in the presence of a second analyte, to emit emission light at a second emission wavelength in response to irradiation with the excitation light at the second excitation wavelength; receiving, using a first emission waveguide, emission light emitted from the first reaction zone and provide the emission light to the combined-emission waveguide; receiving, using a second emission waveguide, emission light emitted from the second reaction zone and provide the emission light to the combined-emission waveguide; directing light at the first emission wavelength along a first detection path; directing light at the second emission wavelength along a second detection path; and generating a first electronic signal based on light received by a first detector positioned along the first detection path; and generating a second electronic signal based on light received by a second detector positioned along the second detection path.

Embodiment 96 is the method of Embodiment 95, where, during the first time interval the first electronic signal indicates one or both of a presence and amount of the first analyte in the first sample; and the second electronic signal indicates one or both of a presence and amount of the second analyte in the second reaction zone.

Embodiment 97 is the method of Embodiment 53, further including indexing the first and second illuminators between a first position and a second position, where in the first position, excitation waveguides coupled to the first and second illuminators are configured to guide the excitation light to a first set of detection locations; and in the second position, the excitation waveguides coupled to the first and second illuminators are configured to guide the excitation light to a second set of detection locations.

Embodiment 98 is a system, including a sample cartridge including a first reaction zone configured to hold a first volume of fluid for analysis; and a second reaction zone configured to hold a second volume of fluid for analysis; a fluorometer comprising first and second illuminators and a first detector, wherein the fluorometer is configured to: provide, via a first excitation waveguide, excitation light from the first illuminator to the first reaction zone; provide, via a second excitation waveguide, excitation light from the second illuminator to the second reaction zone; receive, via a combined-emission waveguide, light emitted from the first reaction zone; receive, via the combined-emission waveguide, light emitted from the second reaction zone; and direct at least a first portion of the received light to a first detection path based on a first wavelength of the received light; and wherein the first detector is positioned along the first detection path and is configured to: receive at least a portion of the first portion of light directed to the first detection path; and generate a first electronic signal based on the received portion of the first portion of light.

Embodiment 99 is the system of Embodiment 98, where the fluorometer is further configured to alternate between providing the excitation light from the first illuminator to the first reaction zone and providing the excitation light from the second illuminator to the second reaction zone.

Embodiment 100 is the system of Embodiment 99, where an end of the first excitation waveguide providing the excitation light from the first illuminator and an end of the second excitation waveguide providing the excitation light from the second illuminator are held at a fixed position relative to the sample cartridge.

Embodiment 101 is the system of Embodiment 98, further including a waveguide holder configured to hold an end of the first excitation waveguide providing the excitation light from the first illuminator and an end of the second excitation waveguide providing the excitation light from the second illuminator in a fixed position relative to the sample cartridge.

Embodiment 102 is the system of any one of Embodiments 98-101, where the first illuminator comprises a set of light sources, each of the light sources configured to emit light at a wavelength different from the other light sources; a set of collimating lenses, each collimating lens being associated with one of the light sources and being configured to collimate light emitted by the associated light source; a set of excitation filters, each excitation filter being associated with one of the collimating lenses and its associated light source and being configured to receive the light collimated by the associated collimating lens and filter the collimated light to prevent transmission of a first portion of the collimated light in a first wavelength range and allow transmission of a second portion of the collimated light in a second wavelength range, where the second wavelength range encompasses an excitation wavelength of the excitation light provided by the first illuminator; and an aperture-sharing lens configured to receive the filtered collimated light from the set of excitation filters and direct the received light to the first excitation waveguide; the second illuminator comprises a set of light sources, each of the light sources configured to emit light at a wavelength different from the other light sources; a set of collimating lenses, each collimating lens being associated with one of the light sources and being configured to collimate light emitted by the associated light source; a set of excitation filters, each excitation filter being associated with one of the collimating lenses and its associated light source and being configured to receive the light collimated by the associated collimating lens and filter the collimated light to prevent transmission of a first portion of the collimated light in a first wavelength range and allow transmission of a second portion of the collimated light in a second wavelength range, where the second wavelength range encompasses an excitation wavelength of the excitation light provided by the second illuminator; and an aperture-sharing lens configured to receive the filtered collimated light from the set of excitation filters and direct the received light to the second excitation waveguide; and the system comprises detection optics including one or more lenses configured to: receive, via the combined-emission waveguide, at least a portion of the light emitted from the first reaction zone; receive, via the combined-emission waveguide, at least a portion of the light emitted from the second reaction zone; and one or more dichroic filters configured to direct at least the first portion of the received light to the first detection path based on the first wavelength of the received light.

Embodiment 103 is the system of Embodiment 99, where the fluorometer is configured to index between a first position and a second position, where in the first position, the first excitation waveguide is configured to guide the excitation light from the first illuminator to the first reaction zone and the second excitation waveguide is configured to guide the excitation light from the second illuminator to the second reaction zone; and in the second position, the first excitation waveguide is configured to guide the excitation light from the first illuminator to a third reaction zone of the sample cartridge and the second excitation waveguide is configured to guide the excitation light from the second illuminator to a fourth reaction zone of the sample cartridge.

Embodiment 104 is the system of Embodiment 103, where, when the fluorometer is indexed between the first position and the second position, the first excitation waveguide and the second excitation waveguide remain in a fixed position.

Embodiment 105 is the system of Embodiment 103, where, when the fluorometer is indexed between the first position and the second position, the first excitation waveguide and the second excitation waveguide move.

### BRIEF DESCRIPTION OF THE DRAWINGS

The accompanying drawings, which are incorporated herein and form part of the specification, illustrate various, non-limiting embodiments of the present disclosure. In the drawings, common reference numbers indicate identical or functionally similar elements.

FIG. 1 is a perspective view of an exemplary detection system and associated sample cartridge.

FIG. 2 is a top plan view of the detection system and associated sample cartridge of FIG. 1.

FIG. 3 is a top plan view of the detection system of FIG. 1.

FIG. 4 is a side view of the detection system of FIG. 1 illustrating an optional indexing between different detection positions.

FIG. 5 is a flowchart showing exemplary steps in a method of operating the detection system of FIG. 1.

FIG. 6 is a section side view of an exemplary illuminator of the detection system of FIG. 1.

FIG. 7 is the section side view of the illuminator of FIG. 6 showing the path of illumination/excitation light through the illuminator.

FIG. 8 is a flowchart showing exemplary steps in a method of operating the illuminators illustrated in FIGS. 6 and 7.

FIG. 9 is a schematic view illustrating illumination and collection of emission light from a detection location using the detection system and associated sample cartridge of FIG. 1.

FIG. 10 is a section side view of exemplary detection optics of the detection system of FIG. 1.

FIG. 11 is a flowchart showing exemplary steps in a method of operating the detection optics of FIG. 10.

FIGS. 12-16 show exemplary paths of collected emission light through the detection optics of FIG. 10 for different detection synchronization/timing scenarios.

FIG. 17 is a schematic of an exemplary detection computer that may be communicatively coupled to the detector module of the detection system of FIG. 1.

### DETAILED DESCRIPTION

Unless defined otherwise, all terms of art, notations and other scientific terms or terminology used herein have the same meaning as is commonly understood by one of ordinary skill in the art to which this disclosure belongs. Many of the techniques and procedures described or referenced herein are well understood and commonly employed using conventional methodology by those skilled in the art. As appropriate, procedures involving the use of commercially available kits and reagents are generally carried out in accordance with manufacturer defined protocols and/or parameters unless otherwise noted. All patents, applications, published applications and other publications referred to herein are incorporated by reference in their entirety. If a definition set forth in this section is contrary to or otherwise inconsistent with a definition set forth in the patents, applications, published applications, and other publications that are herein incorporated by reference, the definition set forth in this section prevails over the definition that is incorporated herein by reference.

Unless otherwise indicated or the context suggests otherwise, as used herein, “a” or “an” means “at least one” or “one or more.”

References in the specification to “one embodiment,” “an embodiment,” a “further embodiment,” “an example,” “an exemplary embodiment,” “some aspects,” “a further aspect,” “aspects,” etc., indicate that the embodiment, example, or aspect described may include a particular feature, structure, or characteristic, but every embodiment encompassed by this disclosure may not necessarily include the particular feature, structure, or characteristic. Moreover, such phrases are not necessarily referring to the same embodiment, example, or aspect. Further, when a particular feature, structure, or characteristic is described in connection with an embodiment, such feature, structure, or characteristic is also a description in connection with other embodiments, examples, or aspects, whether or not explicitly described.

To the extent used herein, the term “sample” refers to any substance suspected of containing at least one analyte of interest. The analyte of interest may be, for example, a nucleic acid, a protein, a prion, a chemical, or the like. The substance may be derived from any source, including an animal, an industrial process, the environment, a water source, a food product, or a solid surface (e.g., surface in a medical facility). Substances obtained from animals may include, for example, blood or blood products, urine, mucus, sputum, saliva, semen, tears, pus, stool, nasopharyngeal or genitourinary specimen obtained with a swab or other collective device, and other bodily fluids or materials. The term “sample” will be understood to mean a specimen in its native form or any stage of processing.

This disclosure may use various terms describing relative spatial arrangements and/or orientations or directions in describing the position and/or orientation of a component, apparatus, location, feature, or a portion thereof or direction of movement, force, or other dynamic action. Unless specifically stated, or otherwise dictated by the context of the description, such terms, including, without limitation, top, bottom, above, below, under, on top of, upper, lower, left, right, in front of, behind, beneath, next to, adjacent, between, horizontal, vertical, diagonal, longitudinal, transverse, radial, axial, clockwise, counter-clockwise, etc., are used for convenience in referring to such component, apparatus, location, feature, or a portion thereof or movement, force, or other dynamic action represented in the drawings and are not intended to be limiting.

Unless otherwise indicated, or the context suggests otherwise, terms used herein to describe a physical and/or spatial relationship between a first component, structure, or portion thereof and a second component, structure, or portion thereof, such as, attached, connected, fixed, joined, linked, coupled, or similar terms or variations of such terms, shall encompass both a direct relationship in which the first component, structure, or portion thereof is in direct contact with the second component, structure, or portion thereof or there are one or more intervening components, structures, or portions thereof between the first component, structure, or portion thereof and the second component, structure, or portion thereof.

To the extent used herein, the term “adjacent” refers to being near (spatial proximity) or adjoining. Adjacent objects or portions thereof can be spaced apart from one another or can be in actual or direct contact with one another. In some instances, adjacent objects or portions thereof can be coupled to one another or can be formed integrally with one another.

Unless otherwise stated, any specific dimensions mentioned in this description are merely representative of an exemplary implementation of a device embodying aspects of the disclosure and are not intended to be limiting.

To the extent used herein, the terms “about” or “approximately” apply to all numeric values and terms indicating specific physical orientations or relationships such as horizontal, vertical, parallel, perpendicular, concentric, or similar terms, specified herein, whether or not explicitly indicated. This term generally refers to a range of numbers, orientations, and relationships that one of ordinary skill in the art would consider as a reasonable amount of deviation to the recited numeric values, orientations, and relationships (i.e., having the equivalent function or result) in the context of the present disclosure. For example, and not intended to be limiting, this term can be construed as including a deviation of ±10 percent of the given numeric value, orientation, or relationship, provided such a deviation does not alter the end function or result of the stated value, orientation, or relationship. Therefore, under some circumstances as would be appreciated by one of ordinary skill in the art a value of about or approximately 1% can be construed to be a range from 0.9% to 1.1%.

To the extent used herein, the term “set” refers to a collection of one or more objects. Thus, for example, a set of objects can include a single object or multiple objects. Objects of a set also can be referred to as members of the set. Objects of a set can be the same or different. In some instances, objects of a set can share one or more common properties.

To the extent used herein, the terms “substantially” and “substantial” refer to a considerable degree or extent. When used in conjunction with, for example, an event, circumstance, characteristic, or property, the terms can refer to instances in which the event, circumstance, characteristic, or property occurs precisely as stated as well as instances in which the event, circumstance, characteristic, or property occurs to a close approximation, such as accounting for typical tolerance levels or variability of the embodiments described herein.

To the extent used herein, the terms “optional” and “optionally” or the term “may” (e.g., as in the phrase “may include,” “may comprise,” “may produce,” “may provide,” or similar phrases) mean that the subsequently described, component, structure, element, event, circumstance, characteristic, property, etc. may or may not be included or occur and that the description includes instances where the component, structure, element, event, circumstance, characteristic, property, etc. is included or occurs and instances in which it is not or does not.

To the extent used herein, the term “analyte” refers to a molecule or substance that is detected or subjected to analysis in an assay. Exemplary analytes include nucleic acids, polypeptides, proteins, antigens, and prions.

To the extent used herein, the term “assay” refers to a procedure for detecting and/or quantifying an analyte in a sample. A sample comprising or suspected of comprising the analyte is contacted with one or more reagents and subjected to conditions permissive for generating a detectable signal informative of whether the analyte is present or an amount (e.g., mass or concentration) of the analyte in the sample.

To the extent used herein, the term “analyzer” refers to an automated instrument that is capable of performing one or more steps of an assay, including the step of determining the presence or absence of one or more analytes suspected of being present in a fluid sample.

To the extent used herein, the term “molecular assay” refers to a procedure for specifically detecting and/or quantifying a target molecule, such as a particular nucleic acid. A sample comprising or suspected of comprising the target molecule is contacted with one or more reagents, including at least one reagent specific for the target molecule, and subjected to conditions permissive for generating a detectable signal informative of whether the target molecule is present. For example, where the molecular assay includes an amplification reaction, such as a polymerase chain reaction (PCR), the reagents include primers that may be specific for a target nucleic acid, and the generation of a detectable signal can be accomplished, at least in part, by providing a labeled probe that hybridizes to the amplicon produced by the primers in the presence of the target. Alternatively, the reagents can include an intercalating dye for detecting the formation of double-stranded nucleic acids.

To the extent used herein, the term “immunoassay” refers to a biochemical test that uses an antibody or antigen to determine the presence or concentration of a molecule in a solution.”

To the extent used herein, the term “reagent” refers to any substance or mixture that participates in an assay, other than sample material and products of the assay. Exemplary reagents for use in a molecular assay include nucleotides, enzymes, primers, probes, and salts.

According to various embodiments, suitable reactions or processes can comprise one or more of a sample preparation process, a washing process, a sample purification process, a pre-amplification process, a pre-amplified product purification process, an amplification process, an amplified product purification process, a separation process, a sequencing process, a sequencing product purification process, a labeling process, a detecting process, or the like. Processing components or parts of components can comprise sample preparation components, purification components, pre-amplification reaction components, amplification reaction components, sequencing reaction components, or the like. The skilled artisan can readily select and employ suitable components for a desired reaction or process, without undue experimentation.

According to various embodiments, a fluid processing device is provided that can comprise one or more fluid processing passageways that can comprise one or more elements, for example, one or more of a channel, a branch channel, a valve, a flow splitter, a vent, a port, an access area, a via, a bead, a reagent containing bead, a cover layer, a reaction component, any combination thereof, and the like. Any element can be in fluid communication with another element.

The term “fluid communication” means either direct fluid communication, for example, two regions can be in fluid communication with each other via an unobstructed fluid processing passageway connecting the two regions or can be capable of being in fluid communication, for example, two regions can be capable of fluid communication with each other when they are connected via a fluid processing passageway that can comprise a valve disposed therein, wherein fluid communication can be established between the two regions upon actuating the valve, for example, by dissolving a dissolvable valve disposed in the fluid processing passageway.

The term “in fluid communication” refers to in direct fluid communication and/or capable of direct fluid communication, unless otherwise expressly stated.

To the extent used herein, the terms “first” and “second” preceding the name of an element (e.g., a component, apparatus, location, feature, or a portion thereof or a direction of movement, force, or other dynamic action) are used for identification purposes to distinguish between similar elements, and are not intended to necessarily imply order, nor are the terms “first” and “second” intended to preclude the inclusion of additional similar elements. Furthermore, use of the term “first” preceding the name of an element (e.g., a component, apparatus, location, feature, or a portion thereof or a direction of movement, force, or other dynamic action) does not necessarily imply or require that there be additional, e.g., “second,” “third,” etc., such element(s).

To the extent used herein, the terms or phrases “configured to,” “adapted to,” “operable to,” “constructed and arranged to,” and similar terms mean that the object of the term or phrase includes, constitutes, or otherwise encompasses the requisite structure(s), mechanism(s), arrangement(s), component(s), material(s), algorithm(s), circuit(s), programming, etc. to perform a specified task or tasks or achieve a specified output or characteristic, either automatically or perpetually or selectively when called upon to do so.

As described above, prior to the present disclosure, there was a need for improved compact and portable instruments having florescence-based detection systems. Such systems may support portable or field-deployable diagnostic devices, thereby allowing sensitive chemical/biochemical measurements to be performed in a wider variety of settings and potentially at a lower cost than existing systems. The compact florescence-based detection system of this disclosure enables rapid measurements at multiple wavelengths and in multiple detection locations (e.g., detection wells of a sample cartridge or other sample holder or assay platform), facilitating, for example, PCR reactions, rapid DNA melt curve analysis, or other time-sensitive measurements in a compact footprint. The detection system includes a multi-wavelength fluorometer. In certain embodiments, two or more excitation wavelengths are provided simultaneously and/or on specially configured synchronization/timing schedules, further improving data acquisition rates.

In certain embodiments, each of a plurality of detection locations (e.g., reaction zones of a sample cartridge) is illuminated by a dedicated illuminator. Emission light collected from the two or more detection locations is guided through a shared or combined-emission waveguide, which guides light collected from each illuminated detection location to detection optics, which guide the collected light to different detectors based on wavelength. The illuminators may use aperture sharing to provide one or more wavelengths of excitation light. In this aperture sharing-based approach to illumination, a common aperture is used to provide excitation light at multiple wavelengths from a number of light sources. This disclosure recognizes that aperture sharing on the detection end may be relatively inefficient and result in loss of signal, while aperture sharing on the illumination/excitation end is efficient. As such, the detection system of this disclosure includes an aperture sharing lens or lenses in each illuminator, while employing separate detection optics that are shared to measure light collected from the different detection locations. In some embodiments, the detection optics include multi-band filters and/or multi-edge detectors to reduce the number of detectors needed to measure a given number of analytes in a detection run.

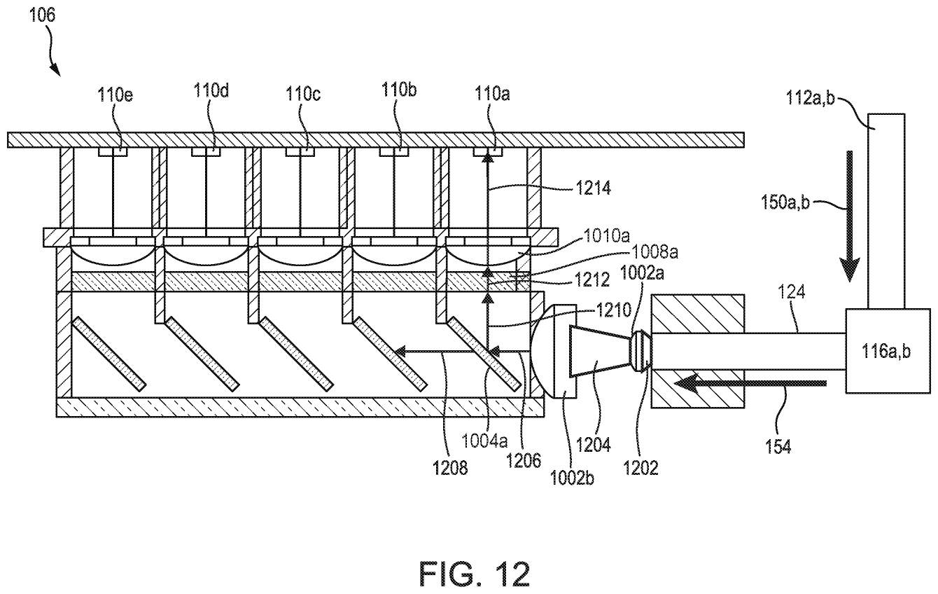

In operation, illumination/excitation at different detection locations may be alternated or appropriately timed or synchronized with the processing of detector signals, such that signals obtained from the detector(s) of the detection optics can be used to reliably and rapidly determine the presence and/or amount of fluorescent material in the detection locations. For example, based on the predefined timing and characteristics (e.g., wavelength) of the illumination/excitation light, signals generated by detectors can be correlated to which sample wells are illuminated (e.g., which illuminator is active at a given time) and which analyte is being measured (e.g., which wavelength of illumination/excitation light is provided at the time). The detection system of this disclosure enables a variety of illumination/detection synchronization strategies, which can be adapted as appropriate for a given application. Some examples of detection illumination/detection synchronization strategies are described in this disclosure, for example, with respect to FIGS. 12-16.

### Detection System Overview

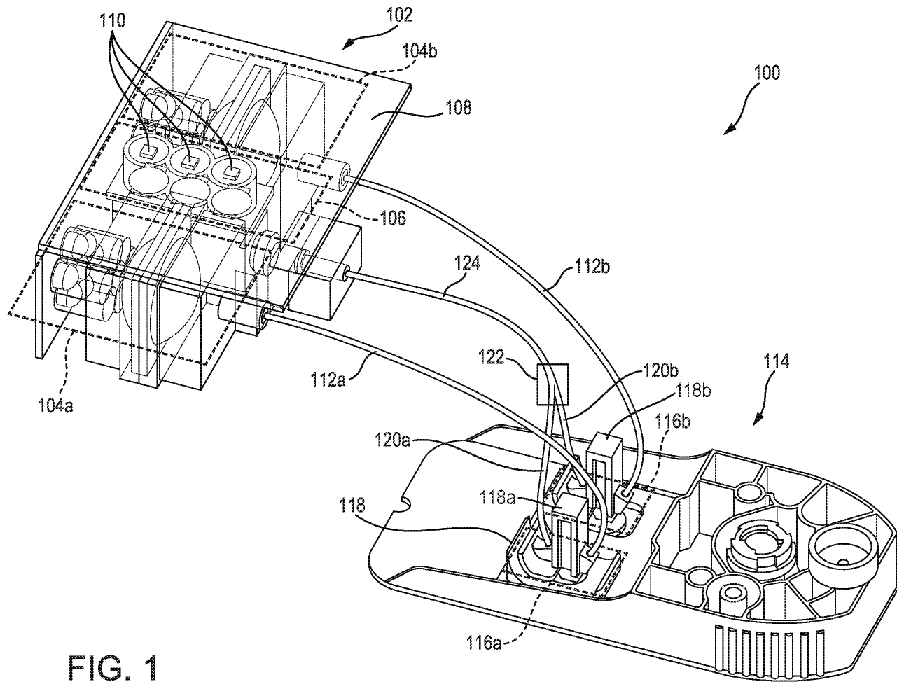

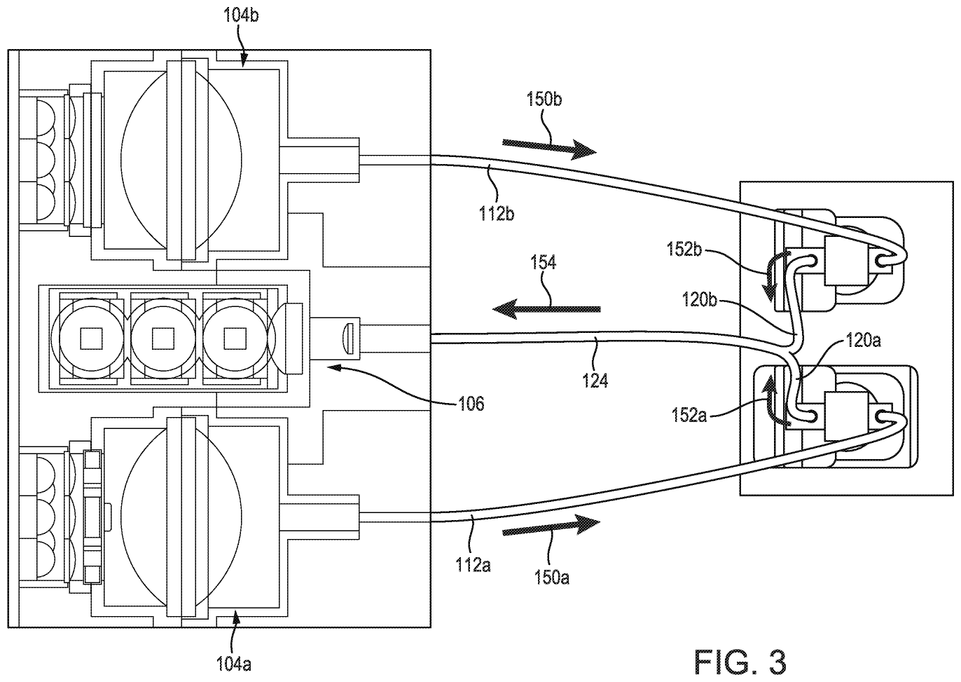

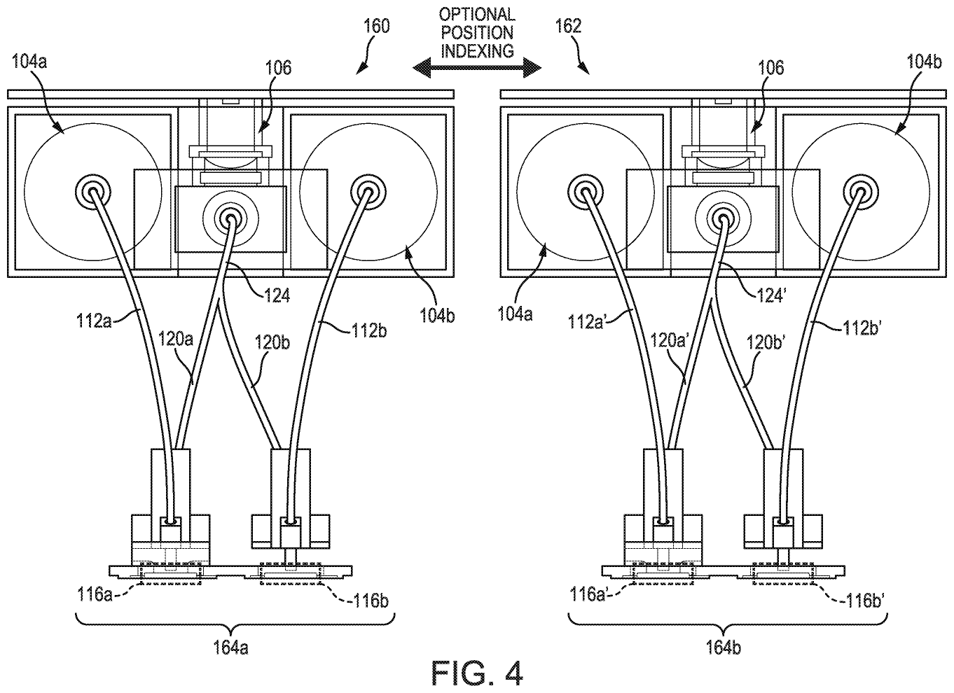

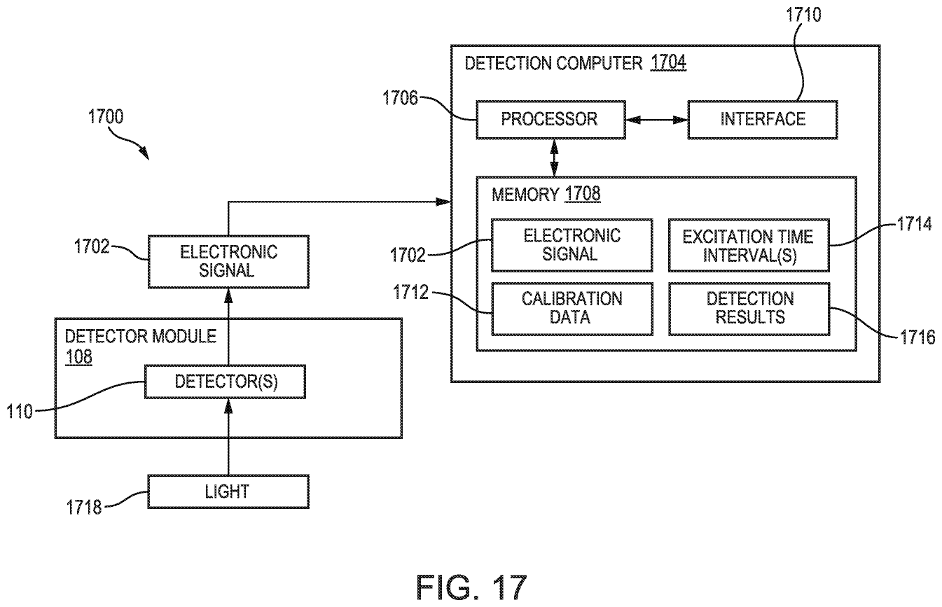

FIGS. 1-4 show various visual perspectives of an exemplary detection system 100 for detecting optical signals indicative of results of chemical analyses, immunoassays, nucleic acid-based tests, and the like. FIG. 3 additionally illustrates the direction of excitation light 150a,b and emission light 152a,b and 154 through waveguides 112a,b, 120a,b, and 124, respectively, of the detection system 100. FIG. 4 additionally illustrates an optional indexing of excitation waveguides 112a,b and emission waveguides 120a,b between different positions to address different sets of detection locations 116a,b, as described further below. The detection system 100 facilitates rapid fluorescence-based measurements with a compact fluorometer 102. The detection system 100 includes the improved fluorometer 102, excitation waveguides 112a,b, a sample cartridge 114, emission waveguides 120a,b, and a combined-emission waveguide 124. Detector(s) 110 of fluorometer 102 may be communicatively coupled to a detection computer (e.g., detection computer 1704 of FIG. 17) to facilitate analysis of signals provided by detector(s) 110 in order to determine results of chemical analyses, immunoassays, nucleic acid-based tests, and the like.

The fluorometer 102 includes two or more illuminators 104a,b, detection optics 106, and a detector module 108 with one or more detectors 110. The fluorometer 102 is generally configured to provide excitation light 150a,b (see FIG. 3) from each illuminator 104a,b, via corresponding excitation waveguide 112a,b, to a corresponding detection location 116a,b of the sample cartridge 114. Light emitted from the detection locations 116a,b is guided as emission light 152a,b (see FIG. 3), via emission waveguides 120a,b, to a combined-emission waveguide 124. The detection optics 106 receive, via the combined-emission waveguide 124, the combined emission light 154 (see FIG. 3) emitted from the detection locations 116a,b. At any given time, combined emission light 154 may include light from none, some or all of the detection locations 116a,b. The timing at which combined-emission light 154 is received is based on the timing at which illumination light is provided by the illuminators 104a,b (see, e.g., FIGS. 12-16 and the corresponding description below). The waveguides 112a,b, 120a,b, and 124 may be any appropriate structure and material for guiding light, such as an optical fiber. The detection optics 106 direct a portion of the received light along one or more detection paths leading to detectors 110 based on the wavelength of the received light. The detector(s) 110 are positioned along each detection path and generate an electronic signal based on the intensity of light reaching each detector 110. For example, a detector 110 may generate an electronic current that is approximately proportional to the intensity of light reaching the detector 110.

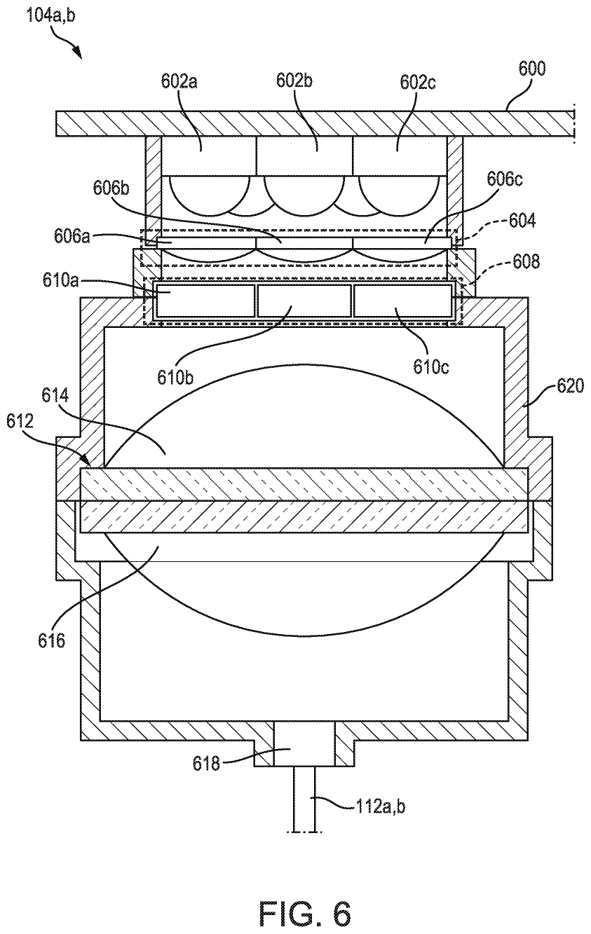

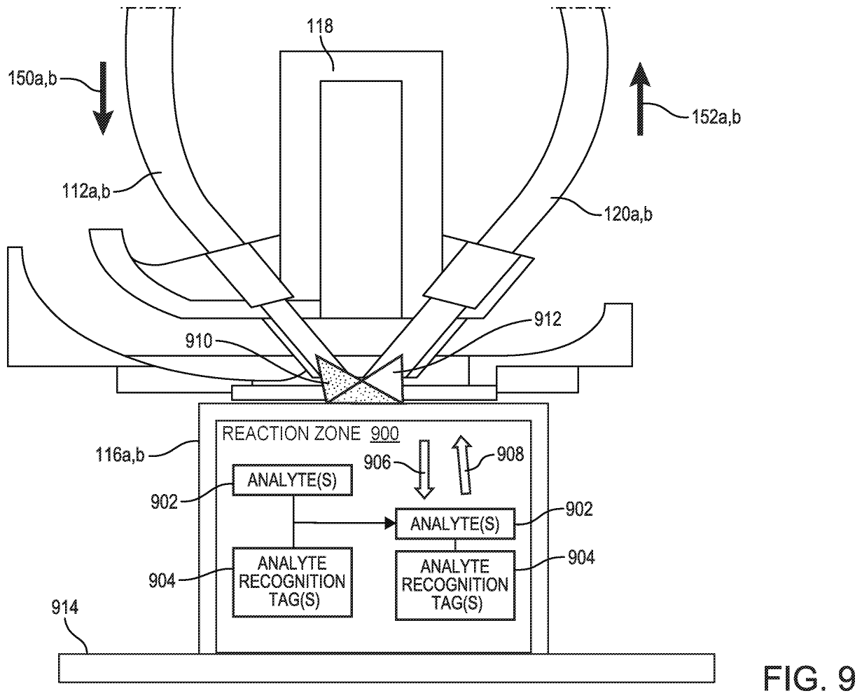

Each illuminator 104a,b is generally configured to provide excitation light 150a,b at one or more wavelengths. An illuminator 104a,b may provide excitation light 150a,b at different wavelengths (e.g., different wavelengths associated with the detection of different analyte recognition tags) simultaneously. As used herein, an “analyte recognition tag” refers to a detectable molecule that can be bound to an analyte to facilitate detection of the analyte. For instance, an analyte recognition tag may include a fluorescent molecule (e.g., a fluorescent dye) that is linked to a probe molecule (e.g., a strand of DNA or RNA, a protein, an antibody, or the like) that specifically binds with an analyte of interest. The wavelengths may be those useful for exciting one or more fluorescent tags used for chemical/biochemical analysis in a reaction zone associated with the detection locations 116a,b (see FIG. 9 and corresponding description below for further details). The illuminators 104a,b may provide excitation light 150a,b at a predefined wavelength using any appropriate approach (e.g., using a light source and one or more filters, lenses, and the like). In certain embodiments, an improved illuminator 104a,b uses one or more aperture sharing lenses to efficiently provide excitation light 150a,b from a set of one or more light emitting diodes (LEDs), as described in greater detail with respect to FIGS. 6-8 below.

An excitation waveguide 112a,b (e.g., a fiber optic cable, light pipe, series of reflectors, or the like) is coupled to each of the illuminators 104a,b. Each of the excitation waveguides 112a,b is configured to guide the excitation light 150a,b (see FIG. 3) from the coupled illuminator 104a,b to a corresponding detection location 116a,b (e.g., in sample cartridge 114). This results in the illumination of at least a portion of the detection location 116a,b with the excitation light 150a,b. Further details of the structure and function of an exemplary illuminator 104a,b are described with respect to FIGS. 6-8 below.

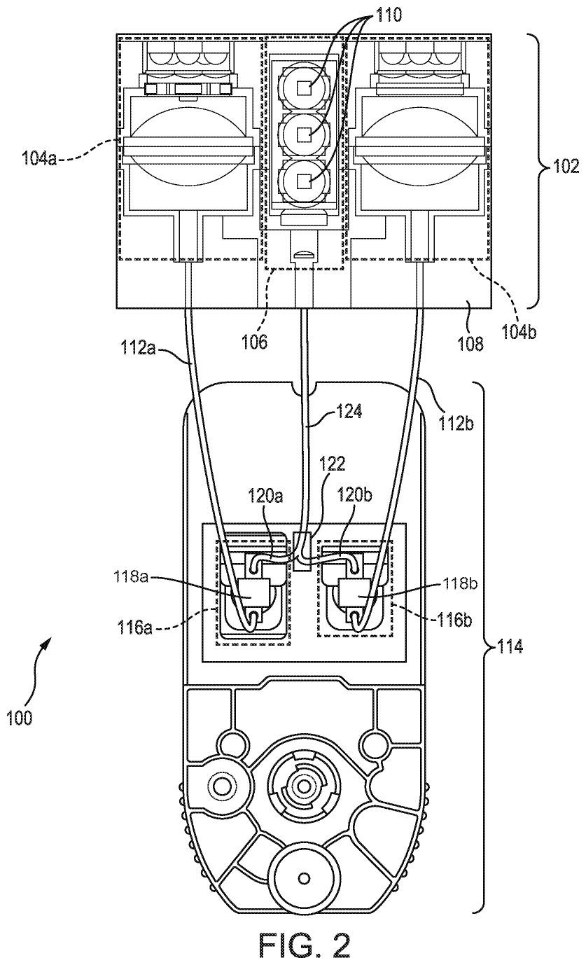

In some embodiments, the excitation waveguide 112a coupled to each of the illuminators 104a,b is held in a fixed position relative to the detection location 116a,b that is illuminated by the illuminator 104a,b. For example, a waveguide holder 118a, b may hold the excitation waveguide 112a,b and emission waveguide 120a,b coupled to each of the illuminators 104a,b in a fixed position relative to the detection location 116a,b illuminated with the excitation light 150a,b provided by the illuminator 104a,b (see FIGS. 1, 2).

In some embodiments, the fluorometer 102 is movable between two or more positions, as shown in the example of FIG. 4. For example, the fluorometer 102 and/or the waveguides 112,a,b and 120a,b may be indexed between a first position 160 and a second position 162. In the first position 160, the excitation waveguides 112a,b coupled to the two or more illuminators 104a,b guide the excitation light 150a,b to a first set 164a of detection locations 116a,b. The emission waveguides 120a,b collect emitted light from this first set 164a of detection locations 116a,b. In the second position 162, the fluorometer 102 is moved to another set of excitation waveguides 112a′,b′ and emission waveguides 120a′,b′ and 124′ that are coupled to a different set 164b of detection locations 116a′,b′, (e.g., another pair of reaction zones of sample cartridge 114 or of a different sample cartridge). The excitation waveguides 112a′,b′ guide the excitation light 150a,b to a second set 164b of detection locations 116a′,b′. The emission waveguides 120a′,b′ collect emitted light from this second set 164b of detection locations 116a′,b′. The distance between the first position 160 and second position 162 may be any appropriate distance depending on the layout of the sample cartridge 114. Generally, the distance between positions 160 and 162 is relatively small, allowing the detection system 100 to index between the positions quickly (e.g., within about 100 milliseconds (ms)) to perform rapid detection in multiple sets 164a,b of detection locations 116a,b and 116a′,b′. In some embodiments, alternative means may be employed to switch between the different sets 164a,b of detection locations 116a,b and 116a′,b′. For example, the detection system 100 may include additional waveguides, beam splitters, and/or the like to alternate between illumination/collection of the different sets 164a,b of detection locations 116a,b and 116a′,b′. In some embodiments, the sample cartridge 114 may be movable between different positions to achieve the same or similar effect, or the waveguides 112,a,b 120a,b may be moved over the top surface of the sample cartridge 114 to address different detection locations 116a,b and 116a′,b′.

As described above, various illumination/detection synchronization strategies may be employed based on a given detection application (e.g., a type of measurement being performed). Exemplary illumination/detection synchronization strategies are described in greater detail below with respect to FIGS. 12-16. However, a few exemplary illumination strategies that may be performed with illuminators 104a,b are briefly described here. For example, in one exemplary scenario, a first illuminator 104a may provide excitation light 150a at a given excitation wavelength during a first time interval (e.g., an initial time in a range from less than 1 ms to 1 s) and a second illuminator 104b may provide excitation light 150b at the same or a different excitation wavelength during a second time interval (e.g., a subsequent 10 ms to 100 ms) that is different from (e.g., not overlapping with) the first time interval. The first and second time intervals may be the same or different lengths of time. In some embodiments, the first and second time intervals are in a range from about 10 ms to 100 ms. In some embodiments, the first and second time intervals are 20 ms. In this scenario, the combined-emission light 154 (see FIG. 3) received during the first time interval corresponds to light emitted from the first detection location 116a that is illuminated by the first illuminator 104a, and the combined-emission light 154 received during the second time interval corresponds to light emitted from the second detection location 116b that is illuminated by the second illuminator 104b.

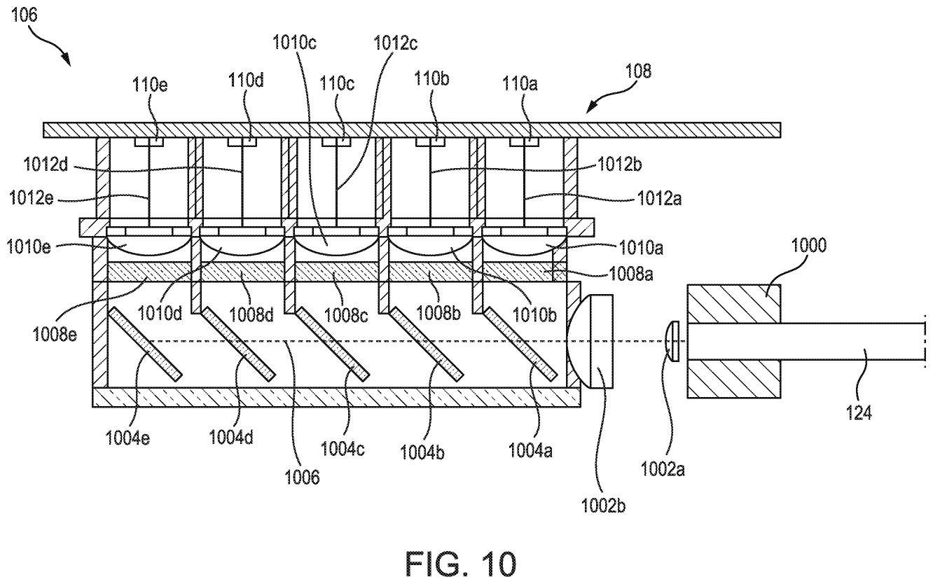

In another exemplary scenario, the first illuminator 104a provides excitation light 150a at a first excitation wavelength, and the second illuminator 104b provides excitation light 150b at a second excitation wavelength that is different from the first excitation wavelength. For example, the wavelengths may be different by at least a threshold amount. For instance, a peak intensity of excitation light 150a may be at least a threshold amount (e.g., 2 nm or greater) from a peak intensity of excitation light 150b. In some embodiments, the threshold amount is in a range from 10 nm to 30 nm. The first illuminator 104a may provide the excitation light 150a during a first time interval, and the second illuminator 104b may provide excitation light 150b during at least a portion of the first time interval. As such, during at least a portion of the time interval, the combined emission light 154 includes emission light from both the first and second detection locations 116a,b illuminated by the two illuminators 104a,b. Since the illumination wavelengths are different, emission light 152a and 152b have different wavelengths, and the detection optics 106 (described further below) can detect both emission light 152a and 152b from the combined emission light 154 by directing the light 152a and 152b to different detectors 110a,b at the same time (e.g., using dichroic filters illustrated in FIG. 10).

In yet another exemplary scenario, the first illuminator 104a provides excitation light 150a at a first excitation wavelength and a second excitation wavelength that is different from the first excitation wavelength (i.e., at two different wavelengths corresponding to the detection of two different fluorescent tags), and the second illuminator 104b provides excitation light 150b at a third excitation wavelength that is different from the first and second excitation wavelengths (e.g., for the detection of a third fluorescent tag). In this scenario, the excitation light 150a and 150b can be provided during different time intervals or simultaneously. If the excitation light is provided simultaneously or during at least partially overlapping time intervals, the detection optics 106 may direct three portions of the combined emission light 154 (e.g., portions corresponding to the emission wavelengths for the three different excitation wavelengths) to different detectors 110.

In yet another exemplary scenario, the first illuminator 104a provides excitation light 150a at a first excitation wavelength and a second excitation wavelength that is different from the first excitation wavelength during a first time interval, and the second illuminator 104b provides excitation light 150b at one or both of the first excitation wavelength and the second excitation wavelength during a second time interval different from the first time interval. In this scenario, combined-emission light 154 received during the first time interval includes light emitted from the first detection location 116a in response to excitation by the first and second wavelengths of excitation light 150a. This combined-emission light 154 may include emission light at up to two wavelengths, corresponding to the emission wavelengths produced when a fluorescent tag is excited with excitation light 150a of the first and second wavelengths. The detection optics 106 may direct these two different wavelengths of combined-emission light 154 to different detectors 106 to detect the presence and/or amount of analytes associated with the fluorescent tags. During the second time interval, the combined-emission light 154 includes only light emitted from the second detection location 116b.

In yet another exemplary scenario, the first illuminator 104a provides excitation light 150a at a first excitation wavelength and a second excitation wavelength different than the first excitation wavelength, and the second illuminator 104b provides excitation light 150b at a third excitation wavelength and a fourth excitation wavelength different than the third excitation wavelength. Excitation light 150a and 150b may be provided to the two different detection locations 116a,b during different time intervals, such that detection is performed based on wavelength and timing of signals generated at detectors 110. In some cases (e.g., if appropriate dichroic filters are available for the wavelengths involved and if the third and fourth excitation wavelengths are different than the first and second excitation wavelengths), excitation light 150a and 150b may be provided to the two sample regions 116a,b during the same or overlapping time intervals, such that detection is performed based on timing, wavelength, or both.

While exemplary scenarios of timing/synchronizing excitation and emission in the detection system 100 are described above, this disclosure contemplates any other appropriate timing/synchronization being used as appropriate for a given detection application. For example, in some cases, a frequency may be imparted to excitation light 150a and/or 150b, and the frequency of the emission light 152a,b (e.g., received as combined emission light 154) may be used to determine from which detection location 116a,b the light was collected, as described, for example, in U.S. Pat. No. 8,718,948, titled “Systems and methods for distinguishing optical signals of different modulation frequencies in an optical signal detector.”

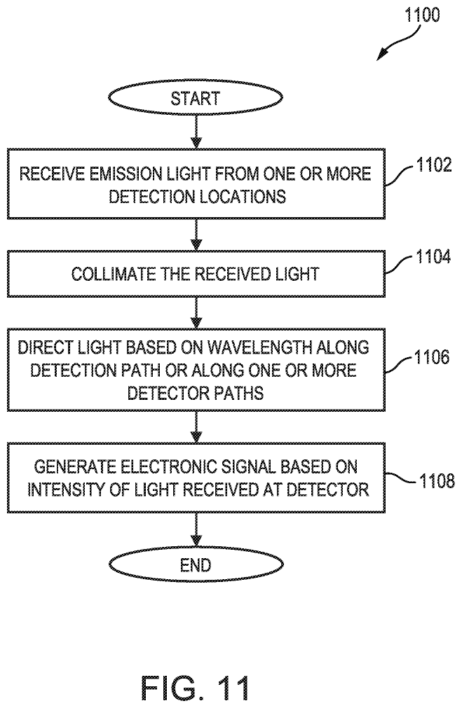

The detection optics 106 include lenses and/or filters for directing combined emission light 154 from the combined-emission waveguide 124 to appropriate detectors 110 of the detector module 108. Further examples and details of the structure and operation of the detection optics 106 are provided with respect to FIGS. 10 and 11 below. The detector module 108 may include one or more detectors 110. Detectors 110 may be photo-diodes or any other appropriate hardware that converts photons into an electronic signal. The detection module 108 may include a circuit board with electrical interconnects for transmitting electronic signals from the detectors 110. As illustrated in and described with respect to FIG. 17 below, the detectors 110 and/or the detector module 108 may be communicatively coupled to a detection computer 1704 that uses signals from the detectors 110 to determine detection results (e.g., the presence and/or amount of some analytes or the like). The detection optics 106 may employ any appropriate combination of lenses, filters, and the like to direct received combined emission light 154 to detectors 110 based on wavelength. In certain embodiments, the fluorometer 102 includes the detection optics 106 described in greater detail with respect to FIGS. 10-11 below.

The sample cartridge 114 is generally any appropriate vessel or vessels that can hold analyte-containing samples in defined detection locations 116a,b. The detection locations 116a,b may be wells of a multi-well plate, chambers of a multi-chamber cassette which may include one or more functional chambers containing, for example, sample fluid, reagents, etc., and which are in fluid communication with reaction chambers comprising the detection locations 116a,b, or predefined regions of any other appropriate analyte-containing sample holder. A detection location 116a,b may include a reaction zone, or region, associated with detecting or measuring an analyte using an analyte recognition tag, such as a fluorescent label joined to a nucleic acid binding moiety, which may be a nucleic acid probe (see, e.g., FIG. 9). For example, a reaction zone may hold a volume of fluid containing a test solution and an analyte recognition tag. As used herein, a “test solution” includes a fluid sample suspected of containing an analyte of interest. As an example, a test solution may include a biological sample, such as saliva, blood, urine, or the like, including as defined above. A test solution may include a carrier fluid, such as a buffer or other appropriate fluid for facilitating detection of an analyte in the biological fluid. The analyte recognition tag is configured, during or after interaction with the analyte, to emit emission light in response to irradiation with excitation light 150a,b provided by an illuminator 104a,b. The emission light 152a,b includes at least a portion of the light emitted by the analyte recognition tag.

In the particular example of FIG. 1, the sample cartridge 114 is a microfluidic cartridge in which the first detection location 116a is a microfluidic reaction zone configured to hold a first volume of fluid for analysis and the second detection location 116b is a second microfluidic reaction zone configured to hold a second volume of fluid for analysis (see FIG. 9 and corresponding description below). As used herein, a “sample cartridge” refers to a container or device capable of holding a sample for analysis. The sample cartridge 114 may include a number of through holes, recesses, and grooves that form microfluidic channels and fluid control valves. A deformable film may be placed opposite the recesses to operate as valves (e.g., by deforming or deflecting the deformable film to open or close the recesses using an external actuator). The microfluidic channels facilitate the flow of fluids for performing sample analysis in reaction zones (e.g., surface immobilization of analytes, fluorescent labeling, etc.). One or more surfaces of the sample cartridge 114 adjacent to reaction zones within the detection locations 116a,b of the sample cartridge 114 are sufficiently transparent to allow excitation light 150a,b and emission light 152a,b to pass to and from the corresponding waveguides 112a,b, 120a,b. An exemplary microfluidic cartridge, which may be used as the sample cartridge 114, is described in U.S. Pat. No. 10,654,039.

The combined-emission waveguide 124 collects emission light 152a,b from the emission waveguides 120a,b and directs, or guides, this combined emission light 154 to the detection optics 106. The detection system 100 may include a waveguide coupler 122 (e.g., one or more lenses, mirrors, and/or the like) that guides emission light 152a,b from emission waveguides 120a,b into the combined-emission waveguide 124. In some embodiments, the combined-emission waveguide 124 and the emission waveguides 120a,b are a continuous waveguide. For example, an optical fiber may be split part way along its length with a portion of the split fibers acting as one emission waveguide 120a and the other portion of split fibers acting as the other emission waveguide 120b.

### Exemplary Method of Operation

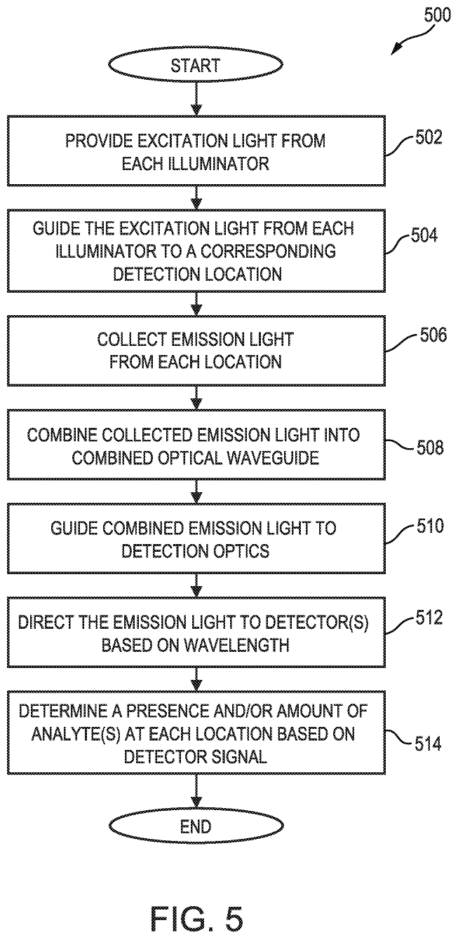

FIG. 5 illustrates an exemplary method 500 of operating the detection system 100 of FIGS. 1-4. The method 500 may begin at step 502 where excitation light 150a,b is provided from each illuminator 104a,b. For example, excitation light 150a,b may be staggered or synchronized in an appropriate manner for a given detection application, as described above and with respect to FIGS. 12-16 below. Further details of the provision of excitation light 150a,b from an exemplary illuminator 104a,b is described with respect to FIGS. 6-8 below.

At step 504, the excitation light 150a,b is guided from each illuminator 104a,b to a corresponding detection location 116a,b. For example, an excitation waveguide 112a,b physically coupled to each illuminator 104a,b (e.g., via a housing) may guide the excitation light 150a,b to a detection location 116a,b, as described with respect to FIGS. 1-4 above thereby illuminating at least a portion of detection locations 116a,b with excitation light 150a,b. At step 506, light emitted from the illuminated detection location 116a,b is collected, or received. For example, light emitted from fluorescent tags within a sample volume at the illuminated detection locations 116a,b may be collected by emission waveguides 120a,b, as described with respect to FIGS. 1-4 above. Further details of excitation light 150a,b reaching an exemplary detection location 116a,b and emission light 152a,b being collected from the detection location 116a,b are described with respect to FIG. 9 below.

At step 508, emission light 152a,b is combined at the combined-emission waveguide 124. At any given time, the resulting combined-emission light 154 may include emission light 152a,b from one or both of the detection locations 116a,b depending on the timing at which excitation light 150a,b is provided to the detection locations 116a,b. At step 510, the combined-emission light 154 is guided to the detection optics 106 via the combined-emission waveguide 124.

At step 512, light received at the detection optics 106 is directed along one or more detection paths leading to detectors 110. The received combined-emission light 154 may be directed to the detectors 110 based on the wavelength of the light 154. For example, a portion of the combined emission light 154 at a wavelength corresponding to the emission wavelength of a fluorescent tag associated with one analyte may directed to one of the detectors 110, while a wavelength corresponding to the emission wavelength of a fluorescent tag associated with another analyte may directed to another of the detectors 110. The structure and operation of the detection optics 106 for performing step 512, are described in greater detail with respect to FIGS. 10 and 11 below.

At step 514, detection results are determined based on an electronic signal provided from the detectors 110. As an example, the detection results may indicate the presence and/or amount of analyte in sample regions associated with the detection locations 116a,b. In some embodiments, detection results are determined using a detection computer as described in greater detail with respect to FIG. 17 below.

Modifications, additions, or omissions may be made to method 500 depicted in FIG. 5. Method 500 may include more, fewer, or other steps. For example, steps may be performed in parallel or in any suitable order.

### Exemplary Illuminator and Its Operation

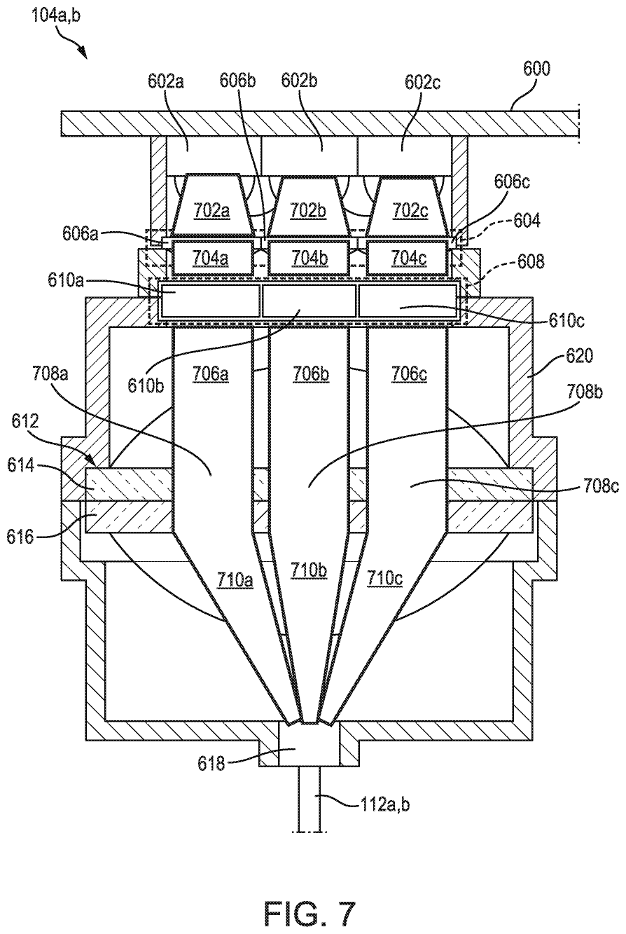

FIGS. 6 and 7 illustrate an exemplary illuminator 104a,b of the detection system 100 of FIG. 1. FIGS. 6 and 7 both show components of the exemplary illuminator 106a. FIG. 7 additionally illustrates paths of light through and amongst the components of the illuminator 104a,b. The exemplary illuminator 104a,b includes a light source module 600 with a plurality of light sources 602a-c, a set 604 of collimating lenses 606a-c, a set 608 of excitation filters 610a-c, an aperture sharing lens set 612, a waveguide holder 618, and an illuminator housing 620. The waveguide holder 618 is generally any appropriate structure for holding the excitation waveguide 112a,b in a fixed position relative to the illuminator 104a,b. In some cases, the waveguide holder 618 may attach the excitation waveguide 112a,b to the illuminator 104a,b, such as to the illuminator housing 620. In other cases (e.g., when the illuminator 104a,b can index between different positions 160, 162, as shown in the example of FIG. 4), the waveguide holder 618 may not attach the excitation waveguide 112a,b to the illuminator 104a,b. The illuminator housing 120 is generally any structure for holding the components of the illuminator 104a,b in place.

The exemplary light sources 602a-c of FIGS. 6 and 7 may be light-emitting diodes (LEDs) on the light source module 600 and one or more integrated lenses for providing a beam of emitted light 702a-c. The light source module 600 may be a circuit board containing the LEDs and any other circuitry and/or electrical leads for facilitating their operation. The light source module 600 may be controlled by the detection computer 1704 of FIG. 17 or other electronics. The example of FIGS. 6 and 7 shows three labeled light sources 602a-c in the foreground, while other light sources are in the background of the diagram. In general, the illuminator 104a,b can have any appropriate number of light sources 602a-c for a given detection application (e.g., from one to six or more light sources 602a-c). As an example, each light source 602a-c may emit light at an excitation wavelength of a fluorophore used as an analyte recognition tag (e.g., tag 904 of FIG. 9, described further below). Exemplary fluorophores include the 5-FAM™ fluorophore (carboxyfluorescein) with peak excitation near 495 nanometers (nm) and peak emission near 530 nm, the HEX™ fluorophore (hexachlorofluorescein) with peak excitation near 530 nm and peak emission near 560 nm, the ROX™ fluorophore (rhodamine X) with peak excitation near 580 nm and peak emission near 605 nm, the Quasar® 670 fluorophore with peak excitation near 650 nm and peak emission near 670 nm, the Quasar® 705 fluorophore with peak excitation near 690 nm and peak emission near 705 nm, and ATTO 490LS with peak excitation near 500 nm and peak emission near 660 nm. Each light source 602a-c may emit a wavelength used to detect one of these fluorophores.

The set 604 of collimating lenses 606a-c includes a collimating lens 606a-c for each light source 602a-c, such that a beam of light 702a-c emitted from the light source 602a-c is collimated to form collimated light beam 704a-c. The collimating lenses 606a-c decrease the beam angle of the emitted light 702a-c.

The set 608 of excitation filters 610a-c includes a filter (e.g., a band pass or other appropriate filter) for each light source 602a-c. Each excitation filter filters its corresponding beam of collimated light 704a-c to produce beams of filtered light 706a-c. The excitation filters 610a-c may filter out wavelengths of light not needed for given detection application. For example, light from a given light source 602a-c may include a wide wavelength range that could result in excitation of off-target fluorescent tags. Excitation filters 610a-c may filter the collimated light 704a-c to prevent transmission of a portion of the collimated light 704a-c in a first wavelength range (e.g., not needed for detection) and allow transmission of a second portion of the collimated light 704a-c in a second wavelength range that includes the excitation wavelength of a fluorescent recognition tag (e.g., excludes non-targeted excitation wavelengths). As such, the excitation filters 610a-c may aid in preventing the excitation of fluorescent tags associated with non-targeted analytes.

The aperture sharing lens set 612 includes a first lens 614 that receives the filtered beams of light 706a-c and a second lens 616 that directs the received light 708a-c toward the excitation waveguide 112a,b that is coupled to, or near, the illuminator 104a,b as focused light 710a-c. The first lens 614 collimates the light 706a-c. For example, the first lens 614 may be appropriately curved or otherwise shaped to collimate the light 706a-c. The second lens 616 focuses the collimated light 708a-c. For example, the second lens 616 may be appropriately curved or otherwise shaped to focus the light 708a-c. Details of an exemplary aperture sharing lens are described in U.S. Pat. No. 9,458,451.

In an exemplary operation of an illuminator 104a,b, one or more of the light sources 602a-c may provide emitted light 702a-c for an interval of time (e.g., 30 ms or the like). This emitted light is collimated, filtered, and focused, as illustrated in FIG. 7. The resulting excitation light 150a,b is then provided to a detection location 116a,b via the excitation waveguide 112a,b to perform detection or another fluorescence-based analysis. In some embodiments, two or more wavelengths of light 150a,b may be provided during the same time interval to the same detection location 116a,b. For example, two light sources 602a-c may provide light simultaneously. As a non-limiting example, wavelengths for the detection of FAM and ROX or HEX and Q670 may be emitted simultaneously. This approach allows for rapid fluorescence measurements by the detection system 100 of FIGS. 1-4 in a compact format. For example, multiple wavelengths may be measured in multiple detection locations 116a,b in less than one second with nanomolar sensitivity. This performance is compatible with rapid analysis methods, such as real-time PCR, rapid DNA melting curve analysis, and the like.

In some embodiments, a built-in target (e.g., a PEEK target) may be included for on-board performance monitoring and/or calibration of the illuminators 104a,b. An example of such a built-in target is described in U.S. Pat. No. 11,009,458. In some embodiments, the illuminators 104a,b do not require monitoring for drift and/or do not require temperature compensation, although these operations can be performed if desired.

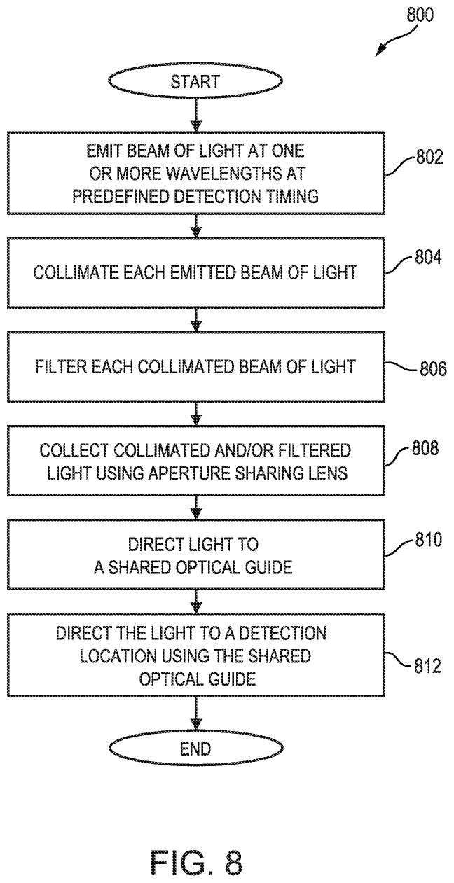

FIG. 8 illustrates an exemplary method 800 of operating the illuminator 104a,b of FIGS. 6-7. The method 800 may begin at step 802, where one or more beams of light 702a-c are emitted, each at a corresponding wavelength. At step 804, each beam of emitted light 702a-c is collimated to form collimated light 704a-c. At step 806, each beam of collimated light 704a-c is filtered to form beams of filtered light 706a-c. At step 808, an aperture sharing lens set 612 collects the beams of filtered light 706a-c, as received light 708a-c. At step 810, the received light 708a-c is directed to an excitation waveguide 112a,b, which functions as a shared waveguide for each beam of focused light 710. After entering the excitation waveguide 112a,b, the light may be referred to as excitation light 150a,b (see FIG. 3). At step 812, the excitation light 150a,b is directed to a detection location 116a,b to facilitate a fluorescence-based measurement (see FIG. 9 and corresponding description below for further details of an exemplary fluorescence measurement in a detection region associated with detection location 116a,b).

Modifications, additions, or omissions may be made to method 800 depicted in FIG. 8. Method 800 may include more, fewer, or other steps. For example, steps may be performed in parallel or in any suitable order.

### Exemplary Illumination and Collection at Detection Location

FIG. 9 illustrates an exemplary portion of the detection device 100 that includes a magnified view of an exemplary detection location 116a,b. FIG. 9 is not drawn to scale. Detection location 116a,b of FIG. 9 includes a reaction zone 900, which is a region of the sample cartridge 114 associated with detecting or measuring an analyte 902 using an analyte recognition tag 904. For example, a reaction zone 900 may hold a volume of fluid containing a test solution, which may or may not include the analyte 902, and an analyte recognition tag 904. The analyte recognition tag 904 emits light 908 in response to irradiation with excitation light 906 in a manner that is dependent upon the presence of the analyte 902. For example, in some cases, emission light 908 may be emitted after irradiation with excitation light 906 only if the analyte is present (e.g., the analyte is directly or indirectly bound to the recognition tag 904, such as when the recognition tag 904 is covalently linked to a probe hybridized to a nucleic acid analyte). In other cases, the presence of the analyte 902 may quench fluorescence of tag 904. Regardless of the detection mechanism employed, the amount of emission light 908 that is emitted can generally be correlated to the presence and/or amount of the analyte 902. The emission light 152a,b includes at least a portion of emission light 908 from the analyte recognition tag 904.

FIG. 9 also illustrates an example of the interface between the detection location 116a,b and the excitation waveguide 112a,b and emission waveguide 120a,b in greater detail. As shown in FIG. 9, the excitation light 150a,b exits the excitation waveguide 112a,b as an excitation cone 910. The angle of excitation cone 910 may be about 30 degrees. Excitation light 906 that reaches the analyte recognition tag 904 is within the excitation cone 910. Meanwhile, the emission waveguide 120a,b receives light from a collection cone 912. A portion of the emitted light 908 (i.e., that portion originating from within the collection cone 912 and directed toward the emission waveguide 120a,b) is collected by the emission waveguide 120a,b and guided as emission light 152a,b to the combined-emission waveguide 124 and subsequently to the detection optics 106 and detector(s) 110 in order to detect the analyte 902 (see FIGS. 1-4). In some embodiments, a reflective surface 914 may be disposed below the reaction zone 900 (e.g., on a bottom surface of the sample cartridge 114 opposite waveguides 112a,b and 120a,b). The reflective surface 914 increases the amount of emission light 908, which is generally emitted in all directions, that reaches the emission waveguide 120a,b and can subsequently reach the detector(s) 110. The reflective surface 914 may increase the sensitivity of measurements performed using the detection system 100.

### Exemplary Detection Optics and Their Operation

FIG. 10 illustrates an example of the detection optics 106 of FIGS. 1-4 in greater detail. The detection optics 106 include a waveguide holder 1000. The waveguide holder 1000 is generally any appropriate structure, such as a mechanical housing, for holding the combined-emission waveguide 124 in a fixed position relative to the detection optics 106. In some cases, the waveguide holder 1000 may attach the combined-emission waveguide 124 to the detection optics 106. In other cases (e.g., when the illuminator 104a,b can index between different positions 160 and 162, as shown in the example of FIG. 4), the waveguide holder 1000 may not attach the combined-emission waveguide 124 to the detection optics 106. The detection optics 106 include one or more collimating lenses 1002a,b that receive light from the combined-emission waveguide 124 and collimate the received light that is initially directed along a collection path 1006. One or more dichroic filters 1004a-e are disposed along the collection path 1006 and configured to direct light along different detection paths 1012a-e based on the wavelength of the received light. The exemplary detection optics 106 of FIG. 10 include five dichroic filters 1004a-e, which may, for example, be obtained from Chroma Technologies Corporation, and five corresponding detectors 110a-e. However, it should be understood that the detection optics can include any appropriate number of dichroic filters 1004a-e and detectors 110a-e (e.g., one or more of each) for a given detection application. An exemplary detector for use as detectors 110a-e is the OSI PIN13Di available from OSI Optoelectronics.

Each dichroic filter 1004a-e generally allows light of certain wavelengths to pass through while reflecting light at other wavelengths. The reflected light is directed along a detection path 1012a-e, while the transmitted light continues along the collection path 1006. For example, each dichroic filter 1004a-e may redirect a portion (e.g., the portion in the wavelength range for which the dichroic filter 1004a-e is reflective to light) of the light originally traveling along the collection path 1006, such that the redirected light travels along the detection path 1012a-e associated with the dichroic filter 1004a-e. A remaining portion (e.g., the portion in the wavelength range for which the dichroic filter 1004a-e is transmissive to light) continues traveling along the collection path 1006.

The dichroic filters 1004a-e may each be configured to direct light associated with a corresponding analyte recognition tag along a detection path 1012a-e leading to a corresponding detector 110a-e, such that each detector 110a-e may be associated with an analyte recognition tag or tags. For example, the first dichroic filter 1004a may direct light at a first wavelength range (e.g., for FAM) along the first detection path 1012a leading to detector 110a. Each subsequent dichroic filter 1004b-e may similarly direct light in different wavelength ranges to the remaining detectors 110b-e. In some embodiments, one or more of the dichroic filters 1004a-c is a multi-band dichroic that reflects light in two different wavelength ranges that are each relevant to the measurement of a different fluorescent recognition tag (e.g., recognition tag 904 of FIG. 9, described above). In such cases, a single detection path 1012a-e may be used to measure two or more wavelengths of light (and corresponding analytes). Further examples of different dichroic filter configurations are described with respect to FIGS. 12-16 below.

Light that is reflected along the detection paths 1012a-e may first pass through an emission filter 1008a-e, which removes wavelengths of light not useful for detection at the detector 110a-e. Exemplary emission filters 1008a-e are those available from Chroma Technologies Corporation. The filtered light may then be focused using a focusing lens 1010a-e, such that most or all of the light reaches the detector 110a-e. Exemplary focusing lenses 1010a-e are those available from Edmund Optics Inc. In response to light reaching a detector 110a-e, an electronic signal is generated (e.g., electronic signal 1702 of FIG. 17). This signal can be used to determine detection results, which may indicate, for example, the presence and/or amount of an analyte or analytes in the detection locations 116a,b.

FIG. 11 illustrates an exemplary method 1100 of operating the detection optics 106 of FIG. 10. The method 1100 may begin at step 1102, where combined emission light 154 is received by the detection optics 106. At step 1104, one or more collimating lenses 1002a,b collimate the received light. The collimated light is then directed along the collection path 1006. At step 1106, the light either continues along the collection path or is directed along one or more of the detection paths 1012a-e based on the wavelength of the light. This may be performed using the dichroic filters 1004a-e, as described with respect to FIG. 10 above. At step 1108, an electronic signal (e.g., electronic signal 1702 of FIG. 17) is generated at one or more detectors 110a-e based on the intensity of light that was directed along the detection path 1012a-e of the detector 101a-e at step 1106. Further details of using the electronic signal to determine detection results are described with respect to FIG. 17 below.

Modifications, additions, or omissions may be made to method 1100 depicted in FIG. 11. Method 1100 may include more, fewer, or other steps. For example, steps may be performed in parallel or in any suitable order.

### Exemplary Illumination/Detection Synchronization and Timing

FIGS. 12-16 illustrate exemplary synchronizations or timings of illumination/excitation and detection in the detection system 100. While these examples are provided, this disclosure contemplates any other appropriate excitation timing that may be appropriate for a given detection application. These synchronization and timing scenarios are illustrated in terms of the times and properties (e.g., wavelengths) at which excitation light 150a,b is provided to different detection locations 116a,b and the times and properties of the combined emission light 154 received and detected using the detection optics 106.

FIG. 12 illustrates an exemplary synchronization/timing scenario in which the same wavelength of excitation light 150a,b is provided to two different detection locations 116a,b at different times (e.g., to detect the presence and/or amount of the same analyte in the two different detection locations 116a,b). The same detector 110a is used to detect the analyte for both detection locations 116a,b. In the exemplary detection scenario of FIG. 12, the first illuminator 104a provides excitation light 150a to the first detection location 116a at a first excitation wavelength during a first time interval (e.g., from less than 1 ms to 1 s). In some embodiments, the first time interval is about 20 ms. As described with respect to FIG. 9 above, the first detection location 116a may be a first reaction zone associated with a first analyte recognition tag provided in such a manner that it emits emission light 152a in response to irradiation with the excitation light 150a only in the presence of an associated analyte (see, e.g., U.S. Pat. No. 5,210,015 (TaqMan® assay), U.S. Pat. No. 5,925,517 (molecular beacons), U.S. Pat. No. 6,361,945 (molecular torches), and U.S. Pat. No. 7,381,818 (minor groove binders)). The second illuminator 104b provides excitation light 150b to the second detection location 116b at the same (first) excitation wavelength as excitation light 150a during a second time interval that is different than the first time interval of the first excitation light 150a. The second detection location 116b is a second reaction zone associated with the same analyte recognition tag as is used in the first detection location 116a. In other words, in the example of FIG. 12, the same type of analyte recognition tag is being illuminated at detection locations 116a,b with the same wavelength of light at different times.

Combined emission light 154 guided by the combined-emission waveguide 124 is received at the detection optics 106 as received light 1202. During the first time interval of excitation light 150a, received light 1202 includes emission light 152a from the first detection location 116a. During the second time interval of excitation light 150b, received light 1202 includes emission light 152b from the second detection location 116b. A first collimating lens 1002a collimates received light 1202 to produce partially collimated light 1204. A second collimating lens 1002b further collimates light 1204 and provides collimated light 1206 along the collection path 1006 of the detection optics 106.

Dichroic filter 1004a directs a portion of light 1206 (e.g., a portion in a wavelength range that is reflected by the dichroic filter 1004a) along detection path 1012a as light 1210 and allows another portion of light 1206 (e.g., a portion in a wavelength range that is transmitted by the dichroic filter 1004a) to continue along the collection path 1006 as light 1208. Light 1210 is filtered by filter 1008a to produce filtered light 1212 and focused by lens 1010a to produce focused light 1214. The detector 110a positioned along detection path 1012a (see FIG. 10) receives the focused light 1214 and generates a corresponding electronic signal that is used to detect the presence of analyte in detection location 116a (based on signal generated during the first time interval) and detection location 116b (based on the signal generated during the second time interval). In the example of FIG. 12, the detection optics 106 may be relatively less complex and more compact by including only a single detector 110a and dichroic filter 1004a.

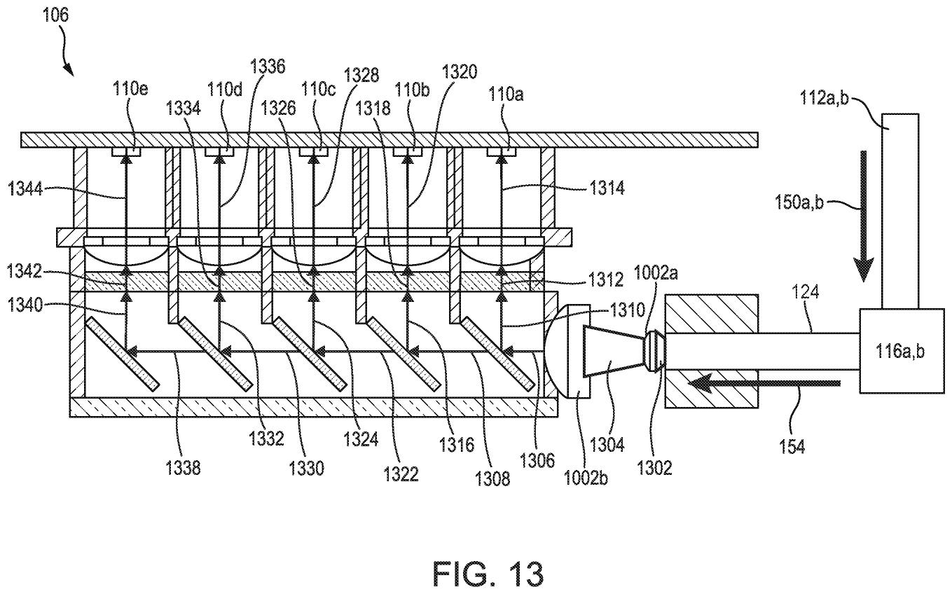

FIG. 13 illustrates an exemplary synchronization/timing scenario in which multiple wavelengths of excitation light 150a,b are provided to two different detection locations 116a,b at different times (e.g., to detect the presence and/or amount of the multiple analytes in the two different detection locations 116a,b). In the example of FIG. 13, five detectors 110a-e (e.g., five detection channels) are used simultaneously to measure analytes in each detection location 116a,b. Depending on available dichroic filters 1004a-e and the analyte recognition tags used, more or fewer detection channels may be available for a given measurement. For example, if dichroic filters 1004a-e do not provide sufficient separation between the various emission wavelengths, fewer detection channels may be used during each excitation time interval.

In the exemplary detection scenario of FIG. 13, the first illuminator 104a provides excitation light 150a to the first detection location 116a at five different excitation wavelengths (e.g., using five different light sources 602a-c of FIGS. 6 and 7) during a first time interval (e.g., from less than 1 ms to 1 s). In some embodiments, the first time interval is about 20 ms The first detection location 116a may be a first reaction zone with analyte recognition tags that emit emission light 152a in response to irradiation with the different wavelengths of excitation light 150a. The second illuminator 104b provides excitation light 150b at the same wavelengths that are included in excitation light 150a during a second time interval. The second time interval may be the same or a different length of time as the first time interval. For example, the second time interval may be from less than 1 ms to 1 s. In some embodiments, the second time interval is 20 ms.

Combined emission light 154 guided by the combined-emission waveguide 124 is received at the detection optics 106 as received light 1302. During the first time interval of excitation light 150a, received light 1302 includes emission light from the first detection location 116a (e.g., one or more of the multiple possible wavelengths that may be emitted by analyte recognition tags in detection location 116a). During the second time interval of excitation light 150b, received light 1302 includes emission light from the second detection location 116b (e.g., one or more of the multiple possible wavelengths that may be emitted by analyte recognition tags in detection location 116b). A first collimating lens 1002a collimates received light 1302 to produce partially collimated light 1304. A second collimating lens 1002b further collimates light 1304 and provides collimated light 1306 along the collection path 1006 (see FIG. 10) of the detection optics 106.

First dichroic filter 1004a (see FIG. 10, dichroic filters 1004a-e are not labeled in FIG. 13) directs a portion of light 1306 along detection path 1012a (see FIG. 10, detection paths 1012a-e are not labeled in FIG. 13) as light 1310 and allows another portion of light 1306 (e.g., a portion in a wavelength range that is transmitted by the dichroic filter 1004a) to continue along the collection path 1006 as light 1308. Light 1310 is filtered by filter 1008a (see FIG. 10, filters 1008a-e are not labeled in FIG. 13) to produce filtered light 1312 and focused by lens 1010a (see FIG. 10, lenses 1010a-e are not labeled in FIG. 13) to produce focused light 1314. The detector 110a positioned along detection path 1012a receives the focused light 1314 and generates a corresponding electronic signal that is used to detect the presence of a first analyte in detection location 116a (based on signal generated during the first time interval) and detection location 116b (based on the signal generated during the second time interval).

The remaining dichroic filters 1004b-e similarly direct light 1316, 1324, 1332, and 1340 along detection paths 1012b-e, respectively, and the electronic signals generated by detectors 110b-e along detection paths 1012b-e are used to detect other analytes in detection location 116a (based on signal generated during the first time interval) and detection location 116b (based on the signal generated during the second time interval). Dichroic filters 1004b-d allow light 1322, 1330, and 1338 to continue traveling along the collection path 1006. Filters 1008b-e filter light 1316, 1324, 1332, and 1340 to generate light 1318, 1326, 1334, and 1342. Focusing lenses 1010b-e focus light 1318, 1326, 1334, and 1342 to generate focused light 1320, 1328, 1336, and 1344, which is directed onto detectors 110b-e to detect light 1320, 1328, 1336, and 1344 at the wavelengths reflected by the corresponding dichroic filters 1004b-e. This approach may be repeated as necessary (e.g., in a second time interval) to detect analytes in the second detection location 116b using excitation light 150b from the second illuminator 104b.

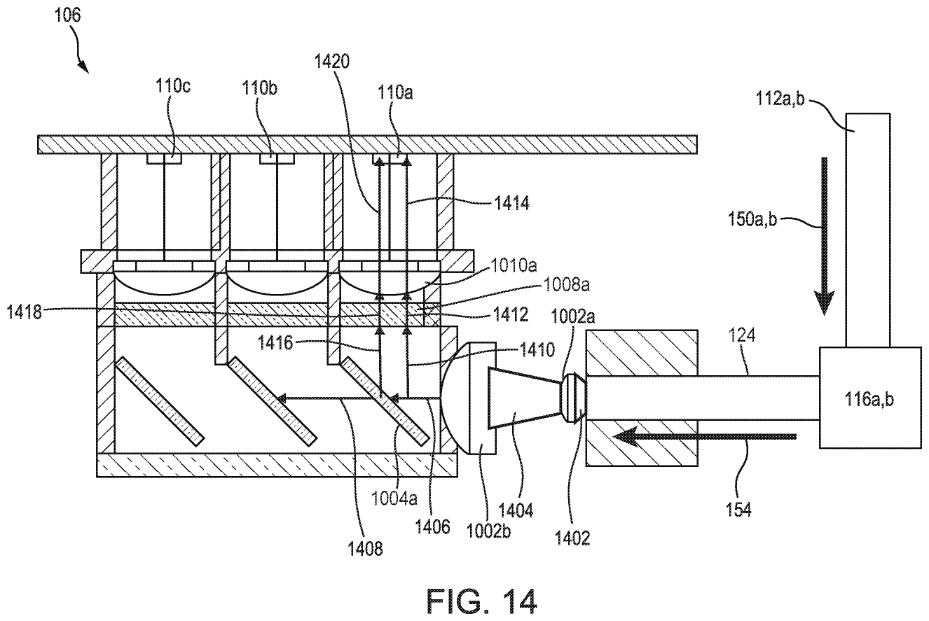

FIG. 14 illustrates an exemplary synchronization/timing scenario in which a detector 110a is used to detect multiple wavelengths of emission light 154 using a multi-band dichroic filter 1004a. In this scenario a single detector 110a can be used to measure two different analytes by illuminating the detection locations 116a,b with different wavelengths of excitation light 150a,b at different times.

In the exemplary detection scenario of FIG. 14, the first illuminator 104a provides excitation light 150a to the first detection location 116a at a first excitation wavelength during a first time interval and at a second wavelength during a second time interval. The first and second time intervals can be the same or different lengths of time. The first and second time intervals can be in a range from less than 1 ms to 1 s. In some embodiments, the first and second time intervals are about 20 ms. Combined emission light 154 guided by the combined-emission waveguide 124 is received at the detection optics 106 as received light 1402. During the first time interval, received light 1402 includes emission light from the first detection location 116a at a first emission wavelength (e.g., if a first analyte is present). During the second time interval, received light 1402 includes emission light from the first detection location 116a at another emission wavelength (e.g., if a second analyte is present). A first collimating lens 1002a collimates received light 1402 to produce partially collimated light 1404. A second collimating lens 1002b further collimates light 1404 and provides collimated light 1406 along the collection path 1006 (see FIG. 10) of the detection optics 106.

Dichroic filter 1004a is a multi-band dichroic filter that reflects the emission wavelength expected to be emitted after irradiation with the first wavelength of light provided during the first time interval and the second wavelength of light provided by the illuminator 104a during the second time interval. During the first time interval, light 1410 is directed along the detection path 1012a and light 1408 continues to travel along the collection path 1006. Light 1410 is filtered by filter 1008a to produce filtered light 1412 and focused by lens 1010a to produce focused light 1414. The detector 110a positioned along detection path 1012a receives the focused light 1414 during the first time interval and generates a corresponding electronic signal that is used to detect the presence of the first analyte in detection location 116a. During the second time interval, light 1416 is directed along the detection path 1012a and light 1408 continues to travel along the collection path 1006. Light 1416 is filtered by filter 1008a to produce filtered light 1418 and focused by lens 1010a to produce focused light 1420. The detector 110a positioned along detection path 1012a receives the focused light 1420 during the second time interval and generates a corresponding electronic signal that is used to detect the presence of the second analyte in detection location 116a. This approach may be repeated as necessary to measure analytes in the second detection location 116b using excitation light 150b from the second illuminator 104b (e.g., in a third and fourth time interval).

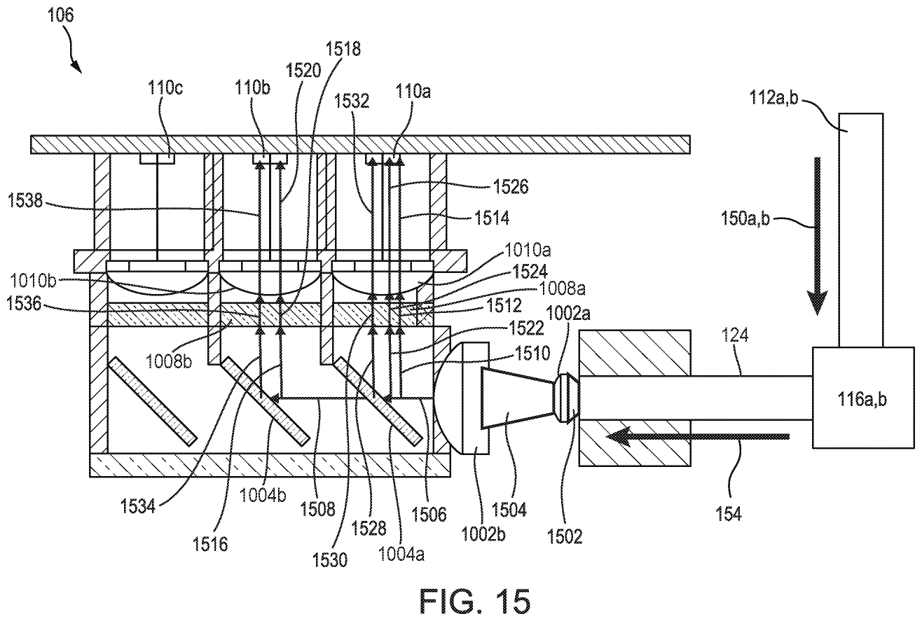

FIG. 15 illustrates an exemplary synchronization/timing scenario in which multiple multi-band dichroic filters 1004a,b are used to detect different analytes simultaneously (e.g., with two wavelengths of excitation light 150a,b provided simultaneously). This exemplary detection scenario facilitates the rapid measurement of multiple analytes with a decreased number of detectors 110a,b, allowing for more compact detection optics 106 and potentially lower manufacturing costs.

In the exemplary detection scenario of FIG. 15, the first illuminator 104a provides excitation light 150a to the first detection location 116a at first and second excitation wavelengths (e.g., for detecting first and second analytes) during a first time interval, at third and fourth wavelengths (e.g., for detecting third and fourth analytes) during a second time interval, and at a fifth wavelength (e.g., for detecting a fifth analyte) during a third time interval. The first, second, and third time intervals can be the same or different lengths of time. The first, second, and third time intervals can be in a range from less than 1 ms to 1 s. In some embodiments, the first, second, and third time intervals are about 20 ms. Combined emission light 154 guided by the combined-emission waveguide 124 is received at the detection optics 106 as received light 1502. During the first time interval, received light 1502 includes emission light from the first detection location 116a at first and second emission wavelengths (e.g., if the first and second analytes are present). During the second time interval, received light 1502 includes emission light from the first detection location 116a at third and fourth emission wavelengths (e.g., if the third and fourth analytes are present). During the third time interval, received light 1502 includes emission light from the first detection location 116a at a fifth emission wavelength (e.g., if the fifth analyte is present). A first collimating lens 1002a collimates received light 1502 to produce partially collimated light 1504. A second collimating lens 1002b further collimates light 1504 and provides collimated light 1506 along the collection path 1006 of the detection optics 106.

The first dichroic filter 1004a is a multi-band dichroic filter that reflects the emission wavelengths expected to be emitted after irradiation by the first, third, and fifth wavelengths provided during the first, second, and third time intervals. The second dichroic filter 1004b is a different multi-band dichroic filter that reflects the emission wavelengths expected to be emitted after irradiation by the second and fourth wavelengths provided during the first and second time intervals.

During the first time interval (with excitation at the first and second excitation wavelengths), light 1510 at the first emission wavelength is directed by dichroic filter 1004a along the detection path 1012a and remaining light 1508 continues to travel along the collection path 1006. Light 1510 is filtered by filter 1008a to produce filtered light 1512 and focused by lens 1010a to produce focused light 1514. The detector 110a positioned along detection path 1012a receives the focused light 1514 during the first time interval and generates a corresponding electronic signal (e.g., an electronic current proportional to light intensity) that is used to detect the presence of the first analyte in detection location 116a. Still during the first time interval, light 1516 at the second emission wavelength is directed by dichroic filter 1004b along detection path 1012b. Light 1516 is filtered by filter 1008b to produce filtered light 1518 and focused by lens 1010b to produce focused light 1520. The detector 110b positioned along detection path 1012b receives the focused light 1520 during the first time interval and generates a corresponding electronic signal that is used to detect the presence of the second analyte in detection location 116a.

During the second time interval, light 1522 at the third wavelength is directed by dichroic filter 1004a along the detection path 1012a and light 1508 continues to travel along the collection path 1006. Light 1522 is filtered by filter 1008a to produce filtered light 1524 and focused by lens 1010a to produce focused light 1526. The detector 110a positioned along detection path 1012a receives the focused light 1526 during the second time interval and generates a corresponding electronic signal that is used to detect the presence of the third analyte in detection location 116a. Still during the second time interval, light 1534 at the fourth emission wavelength is directed by dichroic filter 1004b along detection path 1012b. Light 1534 is filtered by filter 1008b to produce filtered light 1536 and focused by lens 1010b to produce focused light 1538. The detector 110b positioned along detection path 1012b receives the focused light 1538 during the second time interval and generates a corresponding electronic signal that is used to detect the presence of the fourth analyte in detection location 116a.

During the third time interval, light 1528 at the fifth wavelength is directed by dichroic filter 1004a along the detection path 1012a and light 1508 continues to travel along the collection path 1006. Light 1528 is filtered by filter 1008a to produce filtered light 1530 and focused by lens 1010a to produce focused light 1532. The detector 110a positioned along detection path 1012a receives the focused light 1532 during the third time interval and generates a corresponding electronic signal that is used to detect the presence of the fifth analyte in detection location 116a. This approach may be repeated as necessary to measure analytes in the second detection location 116b using excitation light 150b from the second illuminator 104b (e.g., provided in three additional fourth, fifth, and sixth time intervals).

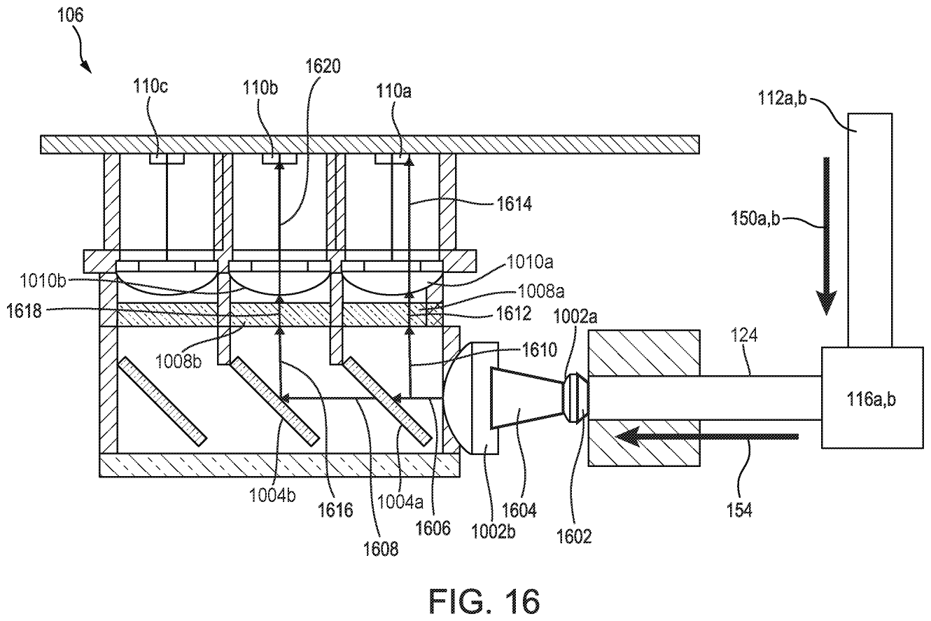

FIG. 16 illustrates an exemplary synchronization/timing scenario in which different wavelengths of excitation light 150a,b are provided to the detection locations 116a,b at the same time. This exemplary detection scenario facilitates the measurement of multiple analytes rapidly by addressing multiple detection locations 116a,b simultaneously.

In the exemplary detection scenario of FIG. 16, the first illuminator 104a provides excitation light 150a to the first detection location 116a at a first excitation wavelength during a time interval, and the second illuminator 104b provides excitation light 150b to the second detection location 116b at a different excitation wavelength during the same, or at least partially overlapping, time interval. The time interval may be in a range from less than 1 ms to 1 s. In some embodiments, the time interval is 20 ms. Combined emission light 154 guided by the combined-emission waveguide 124 is received at the detection optics 106 as received light 1602. The received light 1602 includes emission light from the first detection location 116a (e.g., at a first emission wavelength if a first analyte is present at the first detection location 116a) and second detection location 116b (e.g., at a second emission wavelength if a second analyte is present at the second detection location 116b). A first collimating lens 1002a collimates received light 1602 to produce partially collimated light 1604. A second collimating lens 1002b further collimates light 1604 and provides collimated light 1606 along the collection path 1006 of the detection optics 106.

Dichroic filter 1004a directs a portion of light 1606 along detection path 1012a as light 1610 and allows another portion of light 1608 to continue along the collection path 1006 as light 1608. A portion of light 1608 is directed by dichroic filter 1004b along detection path 1012b as light 1616. Light 1610 is filtered by filter 1008a to produce filtered light 1612 and focused by lens 1010a to produce focused light 1614. The detector 110a positioned along detection path 1012a receives the focused light 1614 and generates a corresponding electronic signal that is used to detect the presence and/or amount of the first analyte in detection location 116a. Light 1616 is filtered by filter 1008b to produce filtered light 1618 and focused by lens 1010b to produce focused light 1620. The detector 110b positioned along detection path 1012b receives the focused light 1620 and generates a corresponding electronic signal that is used to detect the presence of the second analyte in detection location 116b. This approach may be repeated using different excitation wavelengths in subsequent time intervals to detect other analytes in each detection location 116a,b, while addressing both detection locations 116a,b simultaneously.

### Exemplary Detection Computer

FIG. 17 illustrates an exemplary detection computer 1704, which may implement all or portions of the functions of the detection system 100 of FIGS. 1-4. For example, the detection computer 1704 may control functions of the fluorometer 102 and/or sample cartridge 114. FIG. 17 illustrates an electronic signal 1702 generated at a detector 110a-e (see FIG. 10) in response to light 1718 reaching the detector 110a-e. Light 1718 may be light traveling along the detection path 1012a-e of the detector 110a-e (see FIG. 10). The detection computer 1704 may use calibration data 1712 and/or excitation time interval(s) 1714 to determine detection results 1716 based on the electronic signal 1702. For example, the calibration data 1712 may be used to relate a magnitude of the electronic signal 1702 to a corresponding detection result 1716. For example, if the magnitude of the electronic signal 1702 is greater than a threshold value, a detection result 1716 may indicate that an analyte is present and/or that a certain amount of the analyte is present. The excitation time intervals 1714 may be used to determine what the analyte is (e.g., based on which excitation wavelength was provided at a given time and in which detection location the analyte is located). For instance, if the excitation time intervals 1714 indicate that excitation light 150a was provided from the first illuminator 104a for a given time interval, then the electronic signal from 1702 from a detector 110a-e related to an emission wavelength for the excitation wavelength corresponds to an analyte in the first detection location 116a.

The detection computer 1704 includes a processor 1706, memory 1708, and communications interface 1710. The processor 1706 includes one or more processors. The processor 1706 is any electronic circuitry including, but not limited to, one or more central processing unit (CPU) chips, logic units, cores (e.g., a multi-core processor), field-programmable gate array (FPGAs), application specific integrated circuits (ASICs), or digital signal processors (DSPs). The processor 1706 may be a programmable logic device, a microcontroller, a microprocessor, or any suitable combination of the preceding. The processor 1706 is communicatively coupled to and in signal communication with the memory 1708 and interface 1710. The one or more processors are configured to process data and may be implemented in hardware and/or software. For example, the processor 1706 may be 8-bit, 16-bit, 32-bit, 64-bit or of any other suitable architecture. The processor 1706 may include an arithmetic logic unit (ALU) for performing arithmetic and logic operations, processor registers that supply operands to the ALU and store the results of ALU operations, and a control unit that fetches instructions from memory 1708 and executes them by directing the coordinated operations of the ALU, registers and other components.

The memory 1708 is operable to store the electronic signal 1702, calibration data 1712, excitation time intervals 1714, and detection results 1716, and any data, instructions, logic, rules, or code operable to execute the functions of the detection computer 1704 and/or the detection system 100. The memory 1708 includes one or more disks, tape drives, or solid-state drives, and may be used as an over-flow data storage device, to store programs when such programs are selected for execution, and to store instructions and data that are read during program execution. The memory 1708 may be volatile or non-volatile and may include read-only memory (ROM), random-access memory (RAM), ternary content-addressable memory (TCAM), dynamic random-access memory (DRAM), and static random-access memory (SRAM).

The communications interface 1710 is configured to enable wired and/or wireless communications. The communications interface 1710 is configured to communicate data between the detection computer 1704 and components of the detection system 100 of FIGS. 1-4 and, optionally, other network devices, systems, or domain(s). The communications interface 1710 is an electronic circuit that is configured to enable communications between devices. For example, the communications interface 1710 may include one or more serial ports (e.g., USB ports or the like) and/or parallel ports (e.g., any type of multi-pin port) for facilitating this communication. As a further example, the interface 1710 may include a WIFI interface, a local area network (LAN) interface, a wide area network (WAN) interface, a modem, a switch, or a router. The processor 1706 is configured to send and receive data using the network interface 1710. The interface 1710 may be configured to use any suitable type of communication protocol. The network interface 1710 receives electronic signals 1702 from detectors 110a-e of detection module 108.

While several embodiments are provided in the present disclosure, it should be understood that the disclosed systems and methods might be embodied in many other specific forms without departing from the scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system, comprising:
two or more illuminators, each illuminator configured to provide excitation light;
an excitation waveguide coupled to each of the illuminators, wherein each of the excitation waveguides is configured to guide the excitation light from the coupled illuminator to a corresponding location, thereby illuminating at least a portion of the corresponding location with the excitation light;
a combined-emission waveguide configured to guide light emitted from the illuminated locations to detection optics; and
the detection optics comprising one or more lenses, wherein the detection optics are configured to:
receive at least a portion of the emitted light provided from the combined-emission waveguide; and
direct a first portion of the received emitted light along a first detection path based on a first wavelength of the received emitted light.

2. The system of claim 1, further comprising a waveguide holder configured to hold the excitation waveguide coupled to each of the illuminators in a fixed position relative to the location illuminated with the excitation light provided by the illuminator.

3. The system of claim 1, wherein the two or more illuminators comprise:
a first illuminator configured to provide excitation light at a first excitation wavelength during a first time interval; and
a second illuminator configured to provide excitation light at a second excitation wavelength during a second time interval different from the first time interval, wherein the first excitation wavelength and the second excitation wavelength are the same, or the first excitation wavelength and the second excitation wavelength are different, and wherein the second time interval does not overlap with the first time interval, or wherein the second time interval overlaps with the first time interval.

4. The system of claim 1, wherein at least one of the illuminators is configured to provide excitation light at multiple wavelengths.

5. The system of claim 1, wherein each of the illuminators further comprises a set of light sources, each of the light sources being configured to emit light at a wavelength different from the other light sources, wherein each of the illuminators further comprises a set of collimating lenses, each collimating lens being associated with one of the light sources and being configured to collimate light emitted by the associated light source, wherein each of the illuminators further comprises a set of excitation filters, each excitation filter being associated with one of the collimating lenses and its associated light source and being configured to receive the light collimated by the associated collimating lens and filter the collimated light to prevent transmission of a first portion of the collimated light in a first wavelength range and allow transmission of a second portion of the collimated light in a second wavelength range, wherein the second wavelength range encompasses an excitation wavelength of the excitation light provided by the illuminator, and wherein each of the illuminators further comprises an aperture-sharing lens configured to:
receive the filtered collimated light from the set of excitation filters; and
direct the received light to the excitation waveguide coupled to the illuminator.

6. The system of claim 1, further comprising, for each location, an emission waveguide associated with the location and configured to receive emitted light from the location and guide the received emitted light to the combined-emission waveguide; and
a waveguide coupler configured to combine the emission waveguides associated with each of the locations, such that light guided by each emission waveguide is provided to the combined-emission waveguide.

7. The system of claim 1, wherein the detection optics further comprise one or more collimating lenses configured to receive light from the combined-emission waveguide; and collimate the received light;
a first dichroic filter configured to direct the first portion of the collimated light along the first detection path and allow a second portion of the collimated light to proceed towards a second dichroic filter; and the second dichroic filter is configured to direct a portion of the second portion of the collimated light along a second detection path,
wherein the first portion of the collimated light is in a first wavelength range corresponding to an emission wavelength of an analyte recognition tag,
and wherein the system further comprises a detection module comprising:
a first detector positioned in the first detection path and configured to generate a first electronic signal in response to light reaching the first detector; and
a second detector positioned in the second detection path and configured to generate a second electronic signal in response to light reaching the second detector.

8. The system of claim 1, wherein:
the two or more illuminators comprise:
a first illuminator configured to provide excitation light to a first reaction zone at a first excitation wavelength during a first time interval, wherein the first reaction zone is associated with a first analyte recognition tag configured, in the presence of a first analyte, to emit emission light at a first emission wavelength in response to irradiation with the excitation light at the first excitation wavelength; and
a second illuminator configured to provide excitation light to a second reaction zone at a second excitation wavelength during the first time interval, wherein the second reaction zone is associated with a second analyte recognition tag configured, in the presence of a second analyte, to emit emission light at a second emission wavelength in response to irradiation with the excitation light at the second excitation wavelength;
a first emission waveguide is configured to receive emission light emitted from the first reaction zone and provide the emission light to the combined-emission waveguide;
a second emission waveguide is configured to receive emission light emitted from the second reaction zone and provide the emission light to the combined-emission waveguide;
the detection optics comprise:
a first dichroic filter configured to direct light at the first emission wavelength along a first detection path; and
a second dichroic filter configured to direct light at the second emission wavelength along a second detection path; and
a detection module comprises:
a first detector positioned along the first detection path, the first detector configured to:
receive at least a portion of light directed along the first detection path; and
generate a first electronic signal based on the received light; and
a second detector positioned along the second detection path, the second detector configured to:
receive at least a portion of light directed along the second detection path; and
generate a second electronic signal based on the received light.

9. A method, comprising:
providing excitation light from a first illuminator to a first detection location;
providing excitation light from a second illuminator to a second detection location;
receiving, via a combined-emission waveguide, light emitted from the first detection location;
receiving, via the combined-emission waveguide, light emitted from the second detection location; and
directing at least a portion of the received emitted light from the first and second detection locations to a first detection path based on a first wavelength of the received emitted light.

10. The method of claim 9, further comprising:
providing the excitation light from the first illuminator at a first excitation wavelength during a first time interval; and
providing the excitation light from the second illuminator at a second excitation wavelength during a second time interval, wherein the first excitation wavelength and the second excitation wavelength are the same or the first excitation wavelength and the second excitation wavelength are different, and wherein the second time interval does not overlap with the first time interval, or wherein the second time interval overlaps with the first time interval.

11. The method of claim 9, further comprising providing one or both of the excitation light from the first illuminator at multiple wavelengths and the excitation light from the second illuminator at multiple wavelengths.

12. The method of claim 9, further comprising:
providing the excitation light from the first illuminator at a first excitation wavelength and a second excitation wavelength different from the first excitation wavelength; and
providing the excitation light from the second illuminator at a third excitation wavelength different from the first and second excitation wavelengths.

13. The method of claim 9, further comprising:
providing the excitation light from the first illuminator at a first excitation wavelength and a second excitation wavelength different from the first excitation wavelength; and
providing the excitation light from the second illuminator at a third excitation wavelength and a fourth excitation wavelength different from the third excitation wavelength, each of the third and fourth excitation wavelengths being different from the first and second excitation wavelengths.

14. The method of claim 9, further comprising, for the first illuminator:
emitting light at a first wavelength from a first light source; and
emitting light at a second wavelength different than the first wavelength from a second light source; and
using a set of collimating lenses:
collimating light emitted by the first light source using a first collimating lens of the set of collimating lenses; and
collimating light emitted by the second light source using a second collimating lens of the set of collimating lenses, wherein the method further comprises:
using a first excitation filter:
receiving the light collimated by the first collimating lens; and
filtering the light collimated by the first collimating lens to prevent transmission of a first portion of the light collimated by the first collimating lens in a first wavelength range and allow transmission of a second portion of the light collimated by the first collimating lens in a second wavelength range, wherein the second wavelength range encompasses a first excitation wavelength of the excitation light provided by the first illuminator; and
using a second excitation filter:
receiving the light collimated by the second collimating lens;
filtering the light collimated by the second collimating lens to prevent transmission of a first portion of the light collimated by the second collimating lens in a third wavelength range and allow transmission of a second portion of the light collimated by the second collimating lens in a fourth wavelength range, wherein the fourth wavelength range encompasses a second excitation wavelength of the excitation light provided by the second illuminator;
receiving light filtered by both the first excitation filter and the second excitation filter; and
directing the received light to an excitation waveguide coupled to the first illuminator.

15. The method of claim 9, further comprising:
using a first emission waveguide:
receiving light emitted from the first detection location; and
guiding the light emitted from the first detection location to the combined-emission waveguide; and
using a second emission waveguide:
receiving light emitted from the second detection location; and
guiding the light emitted from the second detection location to the combined-emission waveguide.

16. The method of claim 9, further comprising:
receiving light from the combined-emission waveguide;
collimating the received light;
directing at least a first portion of the collimated light along the first detection path;
allowing a second portion of the collimated light to proceed along a collection path; and
directing at least a portion of the second portion of the collimated light along a second detection path, wherein the at least the first portion of the collimated light directed along the first detection path includes one or both of a first emission wavelength of a first analyte recognition tag and a second emission wavelength of a second analyte recognition tag, and wherein the second portion of the collimated light directed along the second detection path includes one or both of a third emission wavelength of a third analyte recognition tag and a fourth emission wavelength of a fourth analyte recognition tag.

17. The method of claim 9, further comprising:
providing the excitation light from the first illuminator to a first reaction zone associated with the first detection location at a first excitation wavelength during a first time interval, wherein the first reaction zone is associated with a first analyte recognition tag configured, in the presence of an analyte, to emit emission light in response to irradiation with the excitation light, and wherein the first reaction zone is the location corresponding to the first illuminator; and
providing the excitation light from the second illuminator to a second reaction zone associated with the second detection location at the first excitation wavelength during a second time interval, wherein the second reaction zone is associated with a second analyte recognition tag configured, in the presence of an analyte, to emit emission light in response to irradiation with the excitation light, the first analyte recognition tag and the second analyte recognition tag being the same analyte recognition tag, and wherein the second reaction zone is the location corresponding to the second illuminator;
receiving, using a first emission waveguide, emission light emitted from the first reaction zone and providing the emission light to the combined-emission waveguide;
receiving, using a second emission waveguide, emission light emitted from the second reaction zone and providing the emission light to the combined-emission waveguide;
receiving, by a detector positioned along the first detection path, at least a first portion of light directed along the first detection path; and
generating an electronic signal based on the received light, wherein a first electronic signal generated during the first time interval indicates one or both of a presence and amount of the analyte in the first reaction zone and a second electronic signal generated during the second time interval indicates one or both of a presence and amount of the analyte in the second reaction zone.

18. The method of claim 9, further comprising:
providing the excitation light from the first illuminator to a first reaction zone associated with the first detection location at a plurality of excitation wavelengths during a first time interval, wherein the first reaction zone is associated with a plurality of first analyte recognition tags, each analyte recognition tag of the plurality of first analyte recognition tags being configured, in the presence of a corresponding analyte, to emit emission light at a corresponding emission wavelength in response to irradiation with an excitation wavelength of the first plurality of wavelengths; and
providing the excitation light from the second illuminator to a second reaction zone associated with the second detection location at the plurality of excitation wavelengths during a second time interval, wherein the second reaction zone is associated with a plurality of second analyte recognition tags, each analyte recognition tag of the plurality of second analyte recognition tags being configured, in the presence of a corresponding analyte, to emit emission light at a corresponding emission wavelength in response to irradiation with an excitation wavelength of the first plurality of wavelengths, and wherein the plurality of first analyte recognition tags and the plurality of second analyte recognition tags are the same analyte recognition tags;
receiving, using a first emission waveguide, emission light emitted from the first reaction zone and providing the emission light from the first reaction zone to the combined-emission waveguide;
receiving, using a second emission waveguide, emission light emitted from the second reaction zone and providing the emission light from the second reaction zone to the combined-emission waveguide;
receiving, by one or more lenses, light from the combined-emission waveguide;
directing light from the combined-emission waveguide to two or more detection paths based on a wavelength of the received light, wherein the two or more detection paths include the first detection path; and
generating electronic signals based at least in part on light received at a plurality of detectors positioned along the two or more detection paths, wherein a first electronic signal generated during the first time interval indicates one or both of a presence and amount of at least one of a plurality of analytes in the first reaction zone and a second electronic signal generated during the second time interval indicates one or both of a presence and amount of at least one of the plurality of analytes in the second reaction zone.

19. The method of claim 9, further comprising:
providing the excitation light from the first illuminator to a first reaction zone associated with the first detection location at a first excitation wavelength during a first time interval and at a second excitation wavelength during a second time interval different from the first time interval, wherein the first reaction zone is associated with a first analyte recognition tag configured, in the presence of a first analyte, to emit emission light at a first emission wavelength in response to irradiation with the excitation light at the first excitation wavelength, and a second analyte recognition tag configured, in the presence of a second analyte, to emit emission light at a second emission wavelength in response to irradiation with the excitation light at the second excitation wavelength; and
providing the excitation light from the second illuminator to a second reaction zone associated with the second detection location at the first excitation wavelength during a third time interval and at the second excitation wavelength during a fourth time interval, wherein the second reaction zone is associated with the first analyte recognition tag and the second analyte recognition tag;
receiving, using a first emission waveguide, emission light emitted from the first reaction zone and providing the emission light to the combined-emission waveguide;
receiving, using a second emission waveguide, emission light emitted from the second reaction zone and providing the emission light to the combined-emission waveguide;
directing, using a dual-band dichroic filter, the light at the first emission wavelength and the second emission wavelength along the first detection path; and
generating an electronic signal based on light received at a detector positioned along the first detection path, wherein a first electronic signal generated during the first time interval indicates one or both of a presence and amount of a first analyte in the first reaction zone, a second electronic signal generated during the second time interval indicates one or both of a presence and amount of a second analyte in the first reaction zone, a third electronic signal generated during the third time interval indicates one or both of a presence and amount of the first analyte in the second reaction zone, and a fourth electronic signal generated during the fourth time interval indicates one or both of a presence and amount of the second analyte in the second reaction zone.

20. The method of claim 9, further comprising:
providing the excitation light from the first illuminator to a first reaction zone associated with the first detection location at a first excitation wavelength and a second excitation wavelength during a first time interval and at a third excitation wavelength and a fourth excitation wavelength during a second time interval, wherein the first reaction zone is associated with:
a first analyte recognition tag configured, in the presence of a first analyte, to emit emission light at a first emission wavelength in response to irradiation with the excitation light at the first excitation wavelength;
a second analyte recognition tag configured, in the presence of a second analyte, to emit emission light at a second emission wavelength in response to irradiation with the excitation light at the second excitation wavelength;
a third analyte recognition tag configured, in the presence of a third analyte, to emit emission light at a third emission wavelength in response to irradiation with the excitation light at the third excitation wavelength; and
a fourth analyte recognition tag configured, in the presence of a fourth analyte, to emit emission light at a fourth emission wavelength in response to irradiation with the excitation light at the fourth excitation wavelength; and
providing the excitation light from the second illuminator to a second reaction zone associated with the second detection location at the first excitation wavelength and the second excitation wavelength during a third time interval and at the third excitation wavelength and the fourth excitation wavelength during a fourth time interval, wherein the second reaction zone is associated with the first, second, third, and fourth analyte recognition tags;
receiving, using a first emission waveguide, emission light emitted from the first reaction zone and providing the emission light to the combined-emission waveguide;
receiving, using a second emission waveguide, emission light emitted from the second reaction zone and providing the emission light to the combined-emission waveguide;
directing, using a first multi-band dichroic filter, light at the first emission wavelength and the third emission wavelength along the first detection path;
directing, using a second multi-band dichroic filter, light at the second emission wavelength and the fourth emission wavelength along a second detection path;
receiving at least a portion of light directed along the first detection path at a first detector positioned along the first detection path;
generating a first electronic signal based on light received by the first detector;
receiving at least a portion of light directed along the second detection path at a second detector positioned along the second detection path;
generating a second electronic signal based on light received by the second detector.

21. The method of claim 9, wherein:
providing the excitation light from the first illuminator to a first reaction zone associated with the first detection location at a first excitation wavelength during a first time interval, wherein the first reaction zone is associated with a first analyte recognition tag configured, in the presence of a first analyte, to emit emission light at a first emission wavelength in response to irradiation with the excitation light at the first excitation wavelength;
providing the excitation light from the second illuminator to a second reaction zone associated with the second detection location at a second excitation wavelength during the first time interval, wherein the second reaction zone is associated with a second analyte recognition tag configured, in the presence of a second analyte, to emit emission light at a second emission wavelength in response to irradiation with the excitation light at the second excitation wavelength;
receiving, using a first emission waveguide, emission light emitted from the first reaction zone and provide the emission light to the combined-emission waveguide;
receiving, using a second emission waveguide, emission light emitted from the second reaction zone and provide the emission light to the combined-emission waveguide;
directing light at the first emission wavelength along a first detection path;
directing light at the second emission wavelength along a second detection path; and
generating a first electronic signal based on light received by a first detector positioned along the first detection path; and
generating a second electronic signal based on light received by a second detector positioned along the second detection path.

22. The method of claim 9, further comprising indexing the first and second illuminators between a first position and a second position, wherein:
in the first position, excitation waveguides coupled to the first and second illuminators are configured to guide the excitation light to a first set of detection locations; and
in the second position, the excitation waveguides coupled to the first and second illuminators are configured to guide the excitation light to a second set of detection locations.

23. A system, comprising:
a sample cartridge comprising:
a first reaction zone configured to hold a first volume of fluid for analysis; and
a second reaction zone configured to hold a second volume of fluid for analysis; and
a fluorometer comprising first and second illuminators and a first detector, wherein the fluorometer is configured to:
provide, via a first excitation waveguide, excitation light from a the first illuminator to the first reaction zone;
provide, via a second excitation waveguide, excitation light from a the second illuminator to the second reaction zone;
receive, via a combined-emission waveguide, light emitted from the first reaction zone;
receive, via the combined-emission waveguide, light emitted from the second reaction zone; and
direct at least a first portion of the received light to a first detection path based on a first wavelength of the received light; and
wherein the first detector is positioned along the first detection path and is configured to:
receive at least a portion of the first portion of light directed to the first detection path; and
generate a first electronic signal based on the received portion of the first portion of light.
